(19) United States
(12) Patent Application Publication
(10) Pub. No.: US 2024/0174881 A1
(43) Pub. Date: May 30, 2024

(54) INK JET RECORDING METHOD AND INK JET RECORDING APPARATUS

(71) Applicant: CANON KABUSHIKI KAISHA, Tokyo (JP)

(72) Inventors: ERI KOBAYASHI, Kanagawa (JP); TSUYOSHI KANKE, Kanagawa (JP); ARIHIRO SAITO, Saitama (JP); SHINYA YUMOTO, Kanagawa (JP)

(21) Appl. No.: 18/515,528

(22) Filed: Nov. 21, 2023

(30) Foreign Application Priority Data
Nov. 25, 2022 (JP) 2022-188253
Nov. 16, 2023 (JP) 2023-194800

(51) Int. Cl. C09D 11/54; B41J 2/155; B41J 2/175

(52) U.S. Cl. CPC C09D 11/54; B41J 2/155; B41J 2/175; B41J 11/002

(57) ABSTRACT

Provided is an ink jet recording method capable of recording an image having satisfactory uniformity and suppressed stickiness on a low-absorbent or non-absorbent recording medium. The ink jet recording method includes recording an image on a low-absorbent or non-absorbent recording medium with an aqueous ink and an aqueous reaction liquid containing a reactant that reacts with the ink by applying the ink and the reaction liquid to the recording medium by a one-pass system. A step of applying the reaction liquid to the recording medium by ejecting the reaction liquid from a first ejection head and a step of applying the ink to the recording medium by ejecting the ink from a second ejection head so that a region to which the aqueous ink is applied and a region to which the reaction liquid is applied are at least partially overlap on the recording medium.

### BACKGROUND OF THE INVENTION

### Field of the Invention

The present invention relates to an ink jet recording method and an ink jet recording apparatus.

### Description of the Related Art

An ink jet recording apparatus is an apparatus that records an image on a recording medium by ejecting a minute ink droplet from an ejection orifice of a recording head. In recent years, the use of the ink jet recording apparatus has been considered also in the fields of label printing and package printing. In the label printing or the package printing, in order to produce a large number of recorded products within a short period of time, there is often adopted a method of recording an image, the method including applying an ink to a roll-shaped recording medium by a so-called one-pass system while unrolling and conveying the recording medium. The one-pass system refers to a system in which the application of a liquid such as an ink to a unit region of the recording medium is performed with one relative scanning between the recording head and the recording medium.

In addition, there is a demand for recording an image by an ink jet recording method on a recording medium having low aqueous ink absorbency or a recording medium having almost no aqueous ink absorbency in addition to a recording medium having high aqueous ink absorbency. Examples of the recording medium having high aqueous ink absorbency (hereinafter also referred to as “absorbent recording medium”) include: a recording medium free of a coating layer such as plain paper; and a recording medium having a thick coating layer such as glossy paper for ink jet. Examples of the recording medium having low aqueous ink absorbency (hereinafter also referred to as “low-absorbent recording medium”) include recording medium each having a thin coating layer, such as art paper and coated paper. An example of the recording medium that hardly absorbs an aqueous ink (hereinafter also referred to as “non-absorbent recording medium”) is a plastic film.

The use of an aqueous ink containing a pigment as an ink has been considered from the viewpoints of an environmental aspect, safety and the like. In the absorbent recording medium, an applied ink droplet easily permeates the recording medium, and hence it is difficult to obtain image quality having an optical density at such a high level as required in recent years. In addition, in the low-absorbent recording medium or the non-absorbent recording medium, the applied ink droplet does not easily permeate the recording medium, and hence an adjacent ink droplet is applied while the fixing of the ink by permeation has almost never occurred. As a result, the ink droplets coalesce to cause blurring and unevenness, and hence it is difficult to obtain high-definition image quality.

In order to solve the above-mentioned problems, there has been proposed the use of a reaction liquid containing a polyvalent metal salt as a reactant that reacts with a component such as a pigment in an ink to cause aggregation and thickening (see Japanese Patent Application Laid-Open No. 2017-213796 and Japanese Patent Application Laid-Open No. 2020-104487).

### SUMMARY OF THE INVENTION

The inventors of the present invention have recorded an image on various recording mediums through use of the ink jet recording apparatus, the aqueous reaction liquid and the aqueous ink proposed in Japanese Patent Application Laid-Open No. 2017-213796 and Japanese Patent Application Laid-Open No. 2020-104487 by a system in which the application of a reaction liquid and an ink to a unit region is performed with one relative scanning between a recording head and each of the recording medium. As a result, it has been found that it is difficult to achieve both of density uniformity when a solid image is recorded (hereinafter also referred to as “uniformity”) and the suppression of stickiness of an image in the low-absorbent recording medium or the non-absorbent recording medium.

Thus, an object of the present invention is to provide an ink jet recording method capable of recording an image having satisfactory uniformity and suppressed stickiness on a low-absorbent recording medium or a non-absorbent recording medium. In addition, another object of the present invention is to provide an ink jet recording apparatus to be used in the ink jet recording method.

Specifically, according to the present invention, there is provided an ink jet recording method comprising recording an image on a recording medium comprising a water absorption amount from contact start to 30 msec ½ in a Bristow method of 10 mL/m2 or less with an aqueous ink and an aqueous reaction liquid comprising a reactant that reacts with the aqueous ink by applying the aqueous ink and the reaction liquid to a unit region with one relative scanning between a recording head and the recording medium, the ink jet recording method comprising: a reaction liquid applying step of applying the reaction liquid to the recording medium by ejecting the reaction liquid from a first ejection head of an ink jet system; and an ink applying step of applying the aqueous ink to the recording medium by ejecting the aqueous ink from a second ejection head of an ink jet system so that a region to which the aqueous ink is applied and a region to which the reaction liquid is applied are at least partially overlap on the recording medium, wherein a temperature of the reaction liquid at a time of being ejected from the first ejection head is lower than a temperature of the aqueous ink at a time of being ejected from the second ejection head, and wherein the reactant comprises a polyvalent metal salt, and the polyvalent metal salt comprises a water solubility at 20° C. of 1% by mass or more to 50% by mass or less.

Further features of the present invention will become apparent from the following description of exemplary embodiments with reference to the attached drawings.

### BRIEF DESCRIPTION OF THE DRAWINGS

FIG. 1 is a schematic view for illustrating an ink jet recording apparatus according to one embodiment of the present invention.

FIG. 2 is a perspective view for illustrating an example of a liquid applying

device.

FIG. 3 is a sectional perspective view for illustrating an example of an ejection element substrate.

FIG. 4 is a schematic view for illustrating an example of a liquid supply system.

### DESCRIPTION OF THE EMBODIMENTS

The present invention is described in more detail below by way of exemplary embodiments. In the present invention, when a compound is a salt, the salt is present as dissociated ions in an ink, but the expression “contain a salt” is used for convenience. In addition, an aqueous ink and reaction liquid for ink jet are sometimes referred to simply as “ink” and “reaction liquid”. Physical property values are values at normal temperature (25° C.), unless otherwise stated. The descriptions “(meth)acrylic acid” and “(meth)acrylate” refer to “acrylic acid or methacrylic acid” and “acrylate or methacrylate”, respectively. In the present invention, “unit” constituting a resin refers to a repeating unit derived from one monomer.

The inventors of the present invention have investigated the reason for the difficulty in achieving both the uniformity of an image and the suppression of stickiness of the image when the low-absorbent recording medium or the non-absorbent recording medium is subjected to one-pass recording. In a recording method by a multi-pass system in which an image is recorded on a recording medium by applying an aqueous reaction liquid and an aqueous ink dividedly a plurality of times, it is relatively easy to adjust the time difference in application to be short, for example, by performing the application of the reaction liquid and the ink to a unit region in the same recording pass. In addition, the application of the reaction liquid and the ink to the unit region can be performed dividedly in a plurality of recording passes, and hence the application order of the ink and the reaction liquid is easily adjusted. For example, when the reaction liquid is applied so as to overlap the region having the ink applied thereto, the reactivity between the reaction liquid and the ink becomes satisfactory, and a uniform image is easily obtained.

In the fields of label printing and package printing, in order to produce a large number of recorded products within a short period of time, there is adopted a recording method by a system that is a so-called one-pass system in which the application of a reaction liquid and an ink to a unit region of a recording medium is performed with one relative scanning between a recording head and the recording medium. As compared to the multi-pass system, in the recording method by the one-pass system, it takes a longer time from the application of the reaction liquid to the unit region to the completion of the application of the final ink of a plurality of inks, though the time varies depending on the conveyance speed of a recording medium and the arrangement of an ejection head. Thus, before the reaction liquid applied to a recording medium is brought into contact with the ink to be applied to the recording medium, a liquid component such as water in the reaction liquid applied to the recording medium is evaporated, and the precipitation of a reactant starts. In order for the precipitated reactant to react with a component in the ink, it is required that the reactant be in a state of being dissolved in water in the ink after being brought into contact with the ink. Thus, the following has been found. When the reactant in the reaction liquid applied to the recording medium is precipitated before the reaction liquid is brought into contact with the ink, the reactivity of the reactant is reduced as compared to the case in which the reactant is brought into contact with the ink while existing in a state of being dissolved in the reaction liquid, and hence the uniformity of an image is liable to be reduced.

In order to suppress the precipitation of the reactant in the reactant liquid applied to the recording medium, it may also be conceived to be effective to use a reactant having high water solubility. However, when a recorded product using the reactant having high water solubility is placed under a high-humidity environment, there arises a problem in that an image of the recorded product is sticky when touched due to the deliquescence of the reactant.

Investigations made by the inventors have found that the above-mentioned problems of a reduction in uniformity of an image and stickiness thereof occur specifically when recording is performed on a low-absorbent recording medium or a non-absorbent recording medium. In view of the foregoing, the inventors have investigated a method of achieving both the uniformity of an image and the suppression of stickiness of the image when recording is performed on the low-absorbent recording medium or the non-absorbent recording medium by the one-pass system, and have found the configuration of the present invention.

In an ink jet recording method of the present invention, a reaction liquid applying step of applying a reaction liquid to a recording medium by ejecting the reaction liquid from a first ejection head of an ink jet system is performed. In addition, an ink applying step of applying an ink to the recording medium by ejecting the ink from a second ejection head of an ink jet system so that a region to which the aqueous ink is applied and a region to which the reaction liquid is applied are at least partially overlap on the recording medium. Then, the temperature of the reaction liquid at a time of being ejected from the first ejection head is set to be lower than the temperature of the ink at a time of being ejected from the second ejection head. When the temperature of the reaction liquid at the time of being ejected is set to a relatively low temperature, the evaporation of a liquid component such as water in the reaction liquid can be suppressed. With this configuration, even when a reactant having a water solubility at 20° C. as low as 1% by mass or more to 50% by mass or less which can suppress the stickiness of an image is used, the precipitation of the reactant can be suppressed. Then, the reactant is present in a state of being dissolved in water in the reaction liquid also at a time of being brought into contact with the ink, and hence the reactant is immediately diffused into the ink to provide satisfactory reactivity. Thus, the uniformity of an image can be improved, and the stickiness of the image can be suppressed. Further, when the temperature of the ink at the time of being ejected is set to be relatively high, the diffusion of the reactant after the ink and the reaction liquid are brought into contact with other can be accelerated to enhance the reactivity. Thus, the uniformity of the image can be improved.

<Ink Jet Recording Method and Ink Jet Recording Apparatus>

An ink jet recording method (hereinafter also simply referred to as “recording method”) of the present invention is a method including recording an image on a recording medium with an aqueous ink and an aqueous reaction liquid containing a reactant that reacts with the aqueous ink. As the recording medium, a low-absorbent recording medium or a non-absorbent recording medium, that is, a recording medium having a water absorption amount from contact start to 30 msec^{1/2} in a Bristow method of 10 mL/m² or less is used. In this recording method, an image is recorded by a so-called one-pass system, that is, by performing the application of the aqueous ink and the reaction liquid to a unit region of the recording medium with one relative scanning between a recording head and the recording medium.

This recording method comprises a reaction liquid applying step of applying the reaction liquid to the recording medium by ejecting the reaction liquid from a first ejection head of an ink jet system. Further, the recording method comprises an aqueous ink applying step of applying the aqueous ink to the recording medium by ejecting the aqueous ink from a second ejection head of an ink jet system so that a region to which the aqueous ink is applied and a region to which the reaction liquid is applied are at least partially overlap on the recording medium. Then, the temperature of the reaction liquid at a time of being ejected from the first ejection head is set to be lower than the temperature of the aqueous ink at a time of being ejected from the second ejection head.

An ink jet recording apparatus (hereinafter also simply referred to as “recording apparatus”) of the present invention is an apparatus to be used in the above-mentioned ink jet recording method. As the above-mentioned reaction liquid in the recording method and recording apparatus of the present invention, a reaction liquid in which a reactant contains a polyvalent metal salt and the polyvalent metal salt has a water solubility at 20° C. of 1% by mass or more to 50% by mass or less is used.

(Ink Jet Recording Apparatus)

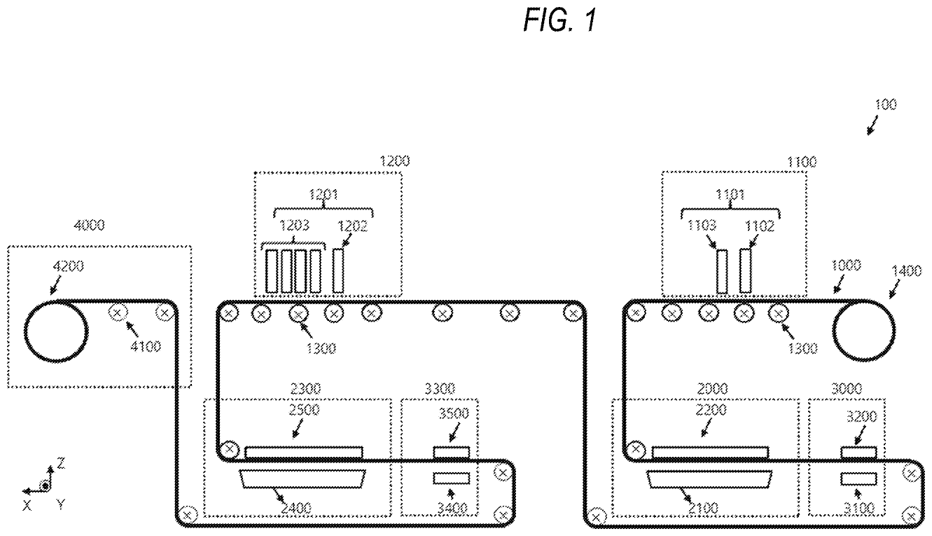

Details about the ink jet recording apparatus are described below with reference to the drawings. FIG. 1 is a schematic view for illustrating the ink jet recording apparatus according to one embodiment of the present invention. The ink jet recording apparatus of this embodiment is an ink jet recording apparatus that records an image on a recording medium wound up into a roll shape with a reaction liquid containing a reactant that reacts with an ink, a first ink and a second ink. An X-direction, a Y-direction and a Z-direction represent the width direction (total length direction), depth direction and height direction of the ink jet recording apparatus, respectively. The recording medium is conveyed in the X-direction.

An ink jet recording apparatus 100 of the embodiment illustrated in FIG. 1 includes: a first recording portion 1100; a first heating portion 2000; a first cooling portion 3000; a second recording portion 1200; a second heating portion 2300; a second cooling portion 3300; and a winding portion 4000. In the first recording portion 1100, various liquids including the first ink are applied to a long recording medium 1000, which has been conveyed from a sheet feeding device 1400 while being supported by a conveying member 1300, by a first liquid applying device 1101. In the first heating portion 2000, the liquids applied to the recording medium 1000 are heated by a first heating device 2100 while the recording medium 1000 is placed along the first conveying member 2200 to maintain the tension, to thereby evaporate and dry volatile components in the liquids such as moisture. After that, the recording medium 1000 is cooled by a first cooling member 3100 while being supported by a first conveying member 3200 of the first cooling portion 3000. Then, in the second recording portion 1200, various liquids including the second ink are applied to the recording medium 1000 by a second liquid applying device 1201 in the same manner as in the case of the first ink. In the second heating portion 2300, the liquids applied to the recording medium 1000 are heated by a second heating device 2400 while the recording medium 1000 is placed along the second conveying member 2500 to maintain the tension, to thereby evaporate and dry volatile components in the liquids such as moisture. Then, the recording medium 1000 is cooled by a second cooling member 3400 while being supported by a second conveying member 3500 of the second cooling portion 3300. The recording medium 1000 having an image recorded thereon is conveyed while being supported by support members 4100 and then wound up by a winding device 4200 in the winding portion 4000.

[Recording Portion]

A recording portion includes the first recording portion 1100 that applies the liquids including the first ink and the second recording portion 1200 that applies the liquids including the second ink. The first recording portion 1100 includes the first liquid applying device 1101. The first liquid applying device 1101 includes a first reaction liquid applying device 1102 and a first ink applying device 1103. The second recording portion 1200 includes the second liquid applying device 1201. The second liquid applying device 1201 includes a second reaction liquid applying device 1202 and a second ink applying device 1203. The first reaction liquid applying device 1102 and the second reaction liquid applying device 1202 illustrated in FIG. 1 are each an example of a unit using an ejection head of an ink jet system. The reaction liquid applying device may be formed by utilizing a gravure coater, an offset coater, a die coater, a blade coater or the like in addition to the ejection head. The application systems of the first reaction liquid applying device 1102 and the second reaction liquid applying device 1202 may be identical to or different from each other. The reaction liquid may be applied by each of the first reaction liquid applying device 1102 and the second reaction liquid applying device 1202 before the application of the ink or may be applied after the application of the ink as long as the liquid can be brought into contact with the ink on the recording medium 1000. However, in order to record a high-quality image on various recording medium having different liquid-absorbing characteristics, the reaction liquid is preferably applied before the application of the ink. An ejection head (recording head) of an ink jet system is used as each of the first ink applying device 1103 and the second ink applying device 1203. Examples of the ejection system of the ejection head serving as each of the first liquid applying device 1101 and the second liquid applying device 1201 may include: a system including causing film boiling in a liquid with an electro-thermal converter to form air bubbles, to thereby eject the liquid; and a system including ejecting the liquid with an electro-mechanical converter. The ejection systems of the first ink applying device 1103 and the second ink applying device 1203 may be identical to or different from each other. In addition, a first reaction liquid to be used together with the first ink and a second reaction liquid to be used together with the second ink may be identical to or different from each other. As the ejection system of the ejection head, the system including causing film boiling in a liquid with an electro-thermal converter to form air bubbles, to thereby eject the liquid is preferably utilized.

In the present invention, the ejection head in the reaction liquid applying device may be referred to as “first ejection head” and the ejection head in the ink applying device may be referred to as “second ejection head.” Alternatively, those ejection heads may be collectively simply referred to as “ejection heads.” As at least any one of the first recording portion 1100 and the second recording portion 1200 described above, a first ejection head that ejects a reaction liquid and a second ejection head that ejects an ink is used.

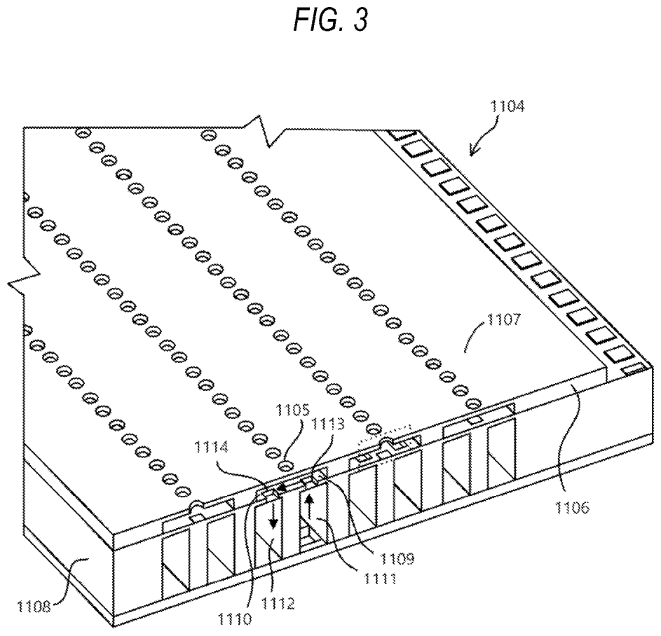

The first liquid applying device 1101 and the second liquid applying device 1201 are each a line head arranged in the Y-direction in an extended manner and its ejection orifices are arrayed in a range covering the image recording region of the recording medium having the maximum usable width. The ejection head has an ejection orifice surface 1107 (FIG. 3) having formed therein ejection orifices on its lower side (recording medium 1000 side). The ejection orifice surface faces the recording medium 1000 with a minute distance of about several millimeters therebetween. The distance between the ejection orifice surface 1107 (FIG. 3) of each of the first liquid applying device 1101 and the second liquid applying device 1201 and the recording medium 1000 is set to preferably 4.0 mm or less. When the distance is set to 4.0 mm or less, the evaporation of a liquid component such as water in the reaction liquid is easily suppressed and the reactivity can be satisfactorily maintained during a period of time from the ejection of the liquid to the adhesion thereof to the recording medium. Thus, the uniformity of an image can be further improved. The distance is set to preferably 0.5 mm or more, more preferably 2.0 mm or less.

The case in which the first ink (white ink) is ejected from the first ink applying device 1103 and the second ink (non-white ink) is ejected from the second ink applying device 1203 is described below as an example. The plurality of second ink applying devices 1203 may be arranged for applying inks of respective colors to the recording medium 1000. For example, when respective color images are recorded with a yellow ink, a magenta ink, a cyan ink and a black ink as the second inks (non-white inks), the four second ink applying devices 1203 that eject the above-mentioned four kinds of inks are arranged side by side in the X-direction. The color tones of the first ink and the second ink are not limited to the foregoing, and the order in which each ink is applied is not limited to the foregoing. The ink and the reaction liquid are hereinafter sometimes collectively referred to as “liquids”.

When recording is preformed, the temperature of the recording medium 1000 may be controlled. The method of controlling the temperature of the recording medium 1000 is not particularly limited, and a known technology may be applied. Specifically, the temperature of the recording medium 1000 may be controlled by: using a heat source such as a near-infrared heater installed on a path along which the recording medium 1000 is conveyed; and controlling the temperature of the heat source with a temperature controller. In addition, a cooling method may be, for example, cooling by heat dissipation or a blowing mechanism. A mechanism that brings a cooled member (e.g., a roller) into contact with the recording medium 1000 may be used. It is preferred to form a configuration in which the temperature of the recording medium is controlled on an upstream side of a line head, more preferably in the vicinity of or directly below the line head in a conveyance path of the recording medium 1000. The temperature of the recording medium 1000 is preferably obtained by reading the temperature of the recording medium 1000 at a time of application of the reaction liquid thereto with an infrared sensor or the like. The temperature of the recording medium 1000 at the time of application of the reaction liquid thereto is preferably equal to or less than the temperature of the reaction liquid at the time of being ejected from the first ejection head. When the temperature of the recording medium 1000 at the time of application of the reaction liquid thereto is set to be equal to or less than the temperature of the reaction liquid at the time of being ejected from the first ejection head, the evaporation of a liquid component such as water in the reaction liquid is suppressed to suppress the precipitation of the reactant, and satisfactory reactivity can be maintained. Thus, the uniformity of an image can be improved.

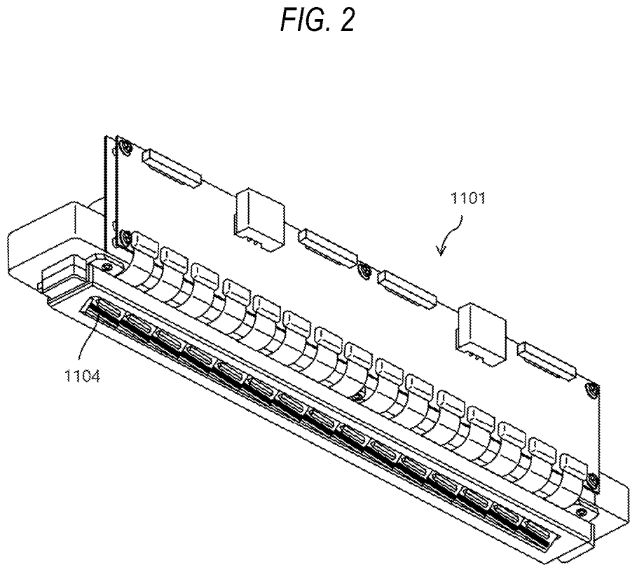

FIG. 2 is a perspective view for illustrating an example of the liquid applying device. The first liquid applying device 1101 and the second liquid applying device 1201 may have the same configuration, and hence the first liquid applying device 1101 is described below as an example. The first liquid applying device 1101 illustrated in FIG. 2 is a line head, and a plurality of ejection element substrates 1104 having arranged therein ejection orifice arrays are linearly arrayed. The ejection element substrates 1104 each have arrayed therein a plurality of ejection orifice arrays.

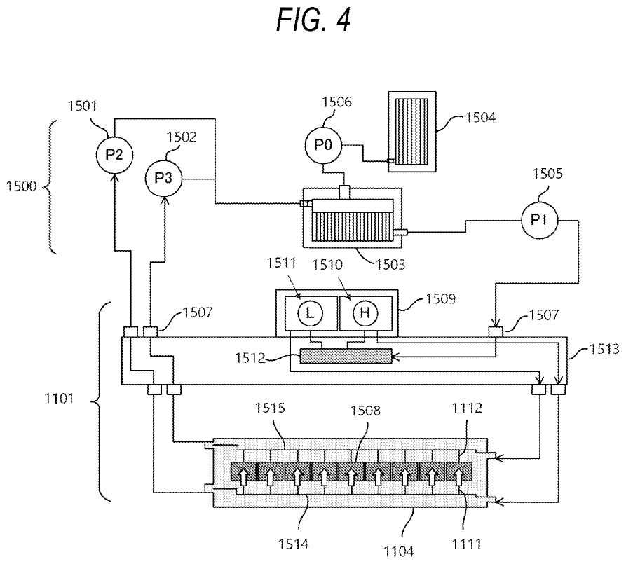

FIG. 3 is a sectional perspective view for illustrating an example of each of the ejection element substrates. The ejection element substrate 1104 illustrated in FIG. 3 includes: an ejection orifice forming member 1106 having opened therein ejection orifices 1105; and a substrate 1108 having arranged thereon an ejection element (not shown). The lamination of the ejection orifice forming member 1106 and the substrate 1108 forms a first flow path 1109 and a second flow path 1110 through which a liquid flows. The first flow path 1109 is a region from an inflow port 1113, into which the liquid flows from an inflow path 1111, to a portion between each of the ejection orifices 1105 and the ejection element (FIG. 4, a liquid chamber 1508). In addition, the second flow path 1110 is a region from the portion between each of the ejection orifices 1105 and the ejection element (FIG. 4, the liquid chamber 1508) to an outflow port 1114 from which the liquid flows out to an outflow path 1112. For example, when a pressure difference is made between the inflow port 1113 and the outflow port 1114 like the inflow port 1113 having a high pressure and the outflow port 1114 having a low pressure, the liquid can be flowed from the high pressure to the low pressure (in a direction indicated by the arrows in FIG. 3). The liquid that has passed through the inflow path 1111 and the inflow port 1113 enters the first flow path 1109. Then, the liquid that has gone through the portion between each of the ejection orifices 1105 and the ejection element (FIG. 4, the liquid chamber 1508) flows to the outflow path 1112 via the second flow path 1110 and the outflow port 1114.

The mass per droplet of the liquid to be ejected from the ejection head is preferably 1.0 ng or more to 5.0 ng or less. When the mass is set to 1.0 ng or more, the total surface area of the liquid droplets per unit volume is decreased to facilitate the suppression of the evaporation of a liquid component such as water in the reaction liquid, and the reactivity can be satisfactorily maintained. Thus, the uniformity of an image can be further improved. In addition, when the mass is set to 5.0 ng or less, the number of the liquid droplets per unit volume is sufficiently increased to facilitate the contact between the reaction liquid and the ink, and hence the reaction liquid and the ink react with each other more efficiently. Thus, the uniformity of the image can be further improved.

[Supply System]

FIG. 4 is a schematic view for illustrating an example of a supply system for the liquids such as the ink. A supply portion 1500 of the first liquid applying device 1101 illustrated in FIG. 4 includes: a first circulation pump (high-pressure side) 1501; a first circulation pump (low-pressure side) 1502; a sub tank 1503; and a second circulation pump 1505. The sub tank 1503 connected to a main tank 1504 serving as a liquid storage portion has an air communication port (not shown) and hence can discharge air bubbles mixed into a liquid to the outside of a circulation system. The sub tank 1503 is also connected to a replenishment pump 1506. A liquid is consumed in the first liquid applying device 1101 by the ejection (discharge) of the liquid from an ejection orifice in, for example, image recording or suction recovery. The replenishment pump 1506 transfers the liquid corresponding to the consumed amount from the main tank 1504 to the sub tank 1503.

The first circulation pump (high-pressure side) 1501 and the first circulation pump (low-pressure side) 1502 each flow the liquid in the first liquid applying device 1101 that has been flowed out of a connection portion (inflow portion) 1507 to the sub tank 1503. A positive-displacement pump having a quantitative liquid-delivering ability is preferably used as each of the first circulation pump (high-pressure side) 1501, the first circulation pump (low-pressure side) 1502 and the second circulation pump 1505. Examples of such positive-displacement pump may include a tube pump, a gear pump, a diaphragm pump and a syringe pump. At the time of the driving of each of the ejection element substrates 1104, the liquid can be flowed from a common inflow path 1514 to a common outflow path 1515 by the first circulation pump (high-pressure side) 1501 and the first circulation pump (low-pressure side) 1502.

A negative pressure control unit 1509 includes two pressure adjusting mechanisms in which control pressures different from each other are set. A pressure adjusting mechanism (high-pressure side) 1510 and a pressure adjusting mechanism (low-pressure side) 1511 are connected to the common inflow path 1514 and the common outflow path 1515 in the ejection element substrate 1104 via a supply unit 1513 having arranged therein a filter 1512 that removes foreign matter from a liquid, respectively. The ejection element substrate 1104 has arranged therein the common inflow path 1514, the common outflow path 1515, and the inflow path 1111 and the outflow path 1112 that communicate to the liquid chamber 1508 serving as a portion between each of the ejection orifices 1105 and the ejection element (not shown). The inflow path 1111 and the outflow path 1112 communicate to the common inflow path 1514 and the common outflow path 1515, respectively. Accordingly, a flow (arrow in FIG. 4) in which part of the liquid passes the inside of the liquid chamber 1508 from the common inflow path 1514 to flow to the common outflow path 1515 occurs. The arrows in FIG. 3 indicate the flow of the liquid in the liquid chamber 1508. That is, as illustrated in FIG. 3, the liquid in the first flow path 1109 flows to the second flow path 1110 via a space between the ejection orifice 1105 and the ejection element.

As illustrated in FIG. 4, the pressure adjusting mechanism (high-pressure side) 1510 is connected to the common inflow path 1514 and the pressure adjusting mechanism (low-pressure side) 1511 is connected to the common outflow path 1515. Accordingly, a pressure difference occurs between the inflow path 1111 and the outflow path 1112. Thus, a pressure difference also occurs between the inflow port 1113 (FIG. 3) communicating to the inflow path 1111 and the outflow port 1114 (FIG. 3) communicating to the outflow path 1112. When a liquid is flowed by the pressure difference between the inflow port 1113 and the outflow port 1114, the flow rate (mm/s) of the liquid is preferably controlled to 0.1 mm/s or more to 10.0 mm/s or less.

A unit that controls the temperatures of the reaction liquid and the ink may be, for example, a heater for adjusting the temperature of a liquid or a heater for ejecting a liquid, which is arranged so as to be brought into contact with an ejection head. In order to control the temperature of a liquid (heating or warming) with the heater for ejecting a liquid, for example, the liquid may be repeatedly energized with a current to such a degree that the liquid is not ejected. The temperature of the liquid may be read, for example, with a temperature sensor installed in the ejection head.

When the temperature of the reaction liquid at the time of being ejected from the first ejection head is set to be lower than the temperature of the ink at the time of being ejected from the second ejection head, both the uniformity of an image and the suppression of stickiness thereof at a time of being recorded by the one-pass system can be achieved. When the temperature of the reaction liquid at the time of being ejected from the first ejection head is set to be lower than the temperature of the ink at the time of being ejected from the second ejection head, the evaporation of a liquid component such as water in the reaction liquid is easily suppressed. As a result, even when a reactant having low water solubility is used in order to make the image less sticky, the precipitation of the reactant is easily suppressed. With this configuration, satisfactory reactivity is obtained. Thus, the uniformity of the image is improved, and the stickiness of the image can be suppressed. In addition, when the temperature of the ink at the time of being ejected from the second ejection head is set to be higher than the temperature of the reaction liquid at the time of being ejected from the first ejection head, the diffusion of the reactant after the ink and the reaction liquid are brought into contact with each other can be accelerated to enhance the reactivity. Thus, the uniformity of the image can be improved. Further, when the temperature of the reaction liquid at the time of being ejected from the first ejection head is set to be lower by 5° C. or more than the temperature of the ink at the time of being ejected from the second ejection head to make a temperature difference, the above-mentioned effect can be further enhanced. The temperature difference is preferably 5° C. or more, and is also preferably 20° C. or less. In addition, the temperature of the reaction liquid at the time of being ejected from the first ejection head is set to preferably 45° C. or less. When the temperature of the reaction liquid is set to 45° C. or less, the evaporation of a liquid component such as water in the reaction liquid is suppressed to suppress the precipitation of the reactant, and satisfactory reactivity can be maintained. Thus, the uniformity of the image can be improved. The temperature of the reaction liquid at the time of being ejected from the first ejection head is set to preferably 15° C. or more, more preferably 25° C. or more. In addition, the temperature of the ink at the time of being ejected from the second ejection head is set to preferably 20° C. or more to 55° C. or less.

[Conveyance System]

As illustrated in FIG. 1, the first recording portion 1100 includes the first liquid applying device 1101 and the conveying member 1300 that conveys the recording medium 1000. The reaction liquid and the ink are applied to the desired positions of the recording medium 1000, which is conveyed by the conveying member 1300, by the first liquid applying device 1101. The first reaction liquid applying device 1102 and the first ink applying device 1103 receive the image signal of recording data to apply the required first reaction liquid and first ink to the respective positions. In addition, the second recording portion 1200 includes the second liquid applying device 1201 and the conveying members 1300 that convey the recording medium 1000, and applies the second required reaction liquid and second ink to the respective positions in the same manner as in the first recording portion 1100. In FIG. 1, although the conveying member 1300 in the form of a conveying roller is illustrated, a spur, a belt, a support plate or the like may be utilized as long as the spur, belt, support plate or the like has a function of conveying the recording medium 1000. The shape and size of the conveying member 1300 at each position in the apparatus may be appropriately set in accordance with the position at which the conveying member 1300 is to be arranged. In order to convey the roll-shaped recording medium 1000 with high accuracy, it is preferred to keep the state in which tension is appropriately applied to the recording medium 1000 by arranging the conveying members 1300 so that the recording medium 1000 has a curved state. The conveyance speed of the recording medium 1000 in the ink jet recording apparatus 100 is set to preferably 50 m/min or less. When the conveyance speed is set to 50 m/min or less, the evaporation of a liquid component such as water in the reaction liquid is easily suppressed with an air flow generated along with the conveyance to suppress the precipitation of the reactant, and the reactivity can be satisfactorily maintained. Thus, the uniformity of an image can be further improved. The conveyance speed is set to preferably 10 m/min or more.

[Heating Portion]

As illustrated in FIG. 1, the first heating portion 2000 includes the first heating device 2100 and the first conveying member 2200. Similarly, the second heating portion 2300 includes the second heating device 2400 and the second conveying member 2500. In the first heating portion 2000 and the second heating portion 2300 illustrated in FIG. 1, the recording medium 1000 is conveyed with its recording surface facing downward in a vertical direction. The recording medium 1000 having recorded thereon the image through the application of the reaction liquid and the ink is heated by the first heating device 2100 and the second heating device 2400 while being conveyed by the first conveying member 2200 and the second conveying member 2500. Thus, the liquid components of the image are evaporated and dried.

The first heating device 2100 and the second heating device 2400 may each have any configuration as long as the devices can heat the recording medium 1000. Conventionally known various devices, such as a warm-air dryer and a heater, may each be used. Of those, a non-contact-type heater, such as a heating wire or an infrared heater, is preferably utilized in terms of safety and energy efficiency. In addition, the utilization of the following mechanism easily improves the drying efficiency: the mechanism has built therein a fan for jetting a heated gas on the recording medium 1000 and blows warm air thereto.

A heating temperature is preferably set so that a liquid component is quickly evaporated and so that the recording medium 1000 is not overdried from the viewpoint of suppressing the deformation of the recording medium 1000. In view of a conveying speed and an environmental temperature, the temperature of a drying unit may be set so that the image of the recording medium has a desired temperature. Specifically, the temperature of the drying unit (e.g., warm air) is set to preferably 40° C. or more to 100° C. or less, more preferably 60° C. or more to 80° C. or less. In addition, when a heated gas is blown to heat the recording medium 1000, an air speed is preferably set to 1 m/s or more to 100 m/s or less. The temperature of air such as warm air may be measured with a K-type thermocouple thermometer. A measuring machine may be specifically, for example, a machine available under the product name “AD-5605H” (manufactured by A&D Company, Limited).

When a liquid such as an ink containing a resin particle and a coloring material is used, the resin particle is softened through heating mainly by the first heating portion 2000 and the second heating portion 2300 to form a film and hence the coloring material can be bound onto the recording medium 1000. In addition, when the ink contains a resin particle, the temperature of the drying unit is set to preferably the temperature equal to or more than the glass transition temperature of the resin particle. With this configuration, the resin particle is easily softened to form a film, and the abrasion resistance of an image can be improved. In addition, when the ink contains a wax particle, the temperature of the drying unit is set to be preferably lower than the melting point of a wax for forming the wax particle. With this configuration, the wax suppressed from melting easily remains on the surface of the image, and the abrasion resistance of the image can be improved.

[Cooling Portion]

The first cooling portion 3000 includes the first cooling member 3100 and the first conveying member 3200, and the second cooling portion 3300 includes the second cooling member 3400 and the second conveying member 3500 (FIG. 1). The first cooling portion 3000 and the second cooling portion 3300 respectively cool the recording medium 1000 that has passed through the first heating portion 2000 and the second heating portion 2300 to have a high temperature. The first cooling member 3100 and the second cooling member 3400 may each have any configuration as long as the members can cool the recording medium 1000. Approaches, such as air cooling and water cooling, may each be utilized. Of those, an approach including blowing a gas that is not heated is preferred in terms of safety and energy efficiency. In addition, the utilization of the following mechanism easily enhances cooling efficiency: the mechanism has built therein a fan for jetting a gas on the recording medium 1000 and blows air thereto. In view of a conveyance speed and an environmental temperature, the temperature of the cooling unit may be set so that the image of the recording medium has a desired temperature. Specifically, the temperature of the cooling unit (e.g., blowing) is set to preferably 20° C. or more to 60° C. or less, more preferably 25° C. or more to 50° C. or less. When a gas is blown to cool the medium, its air speed is set to preferably 1 m/s or more to 100 m/s or less.

[Winding Portion]

The recording medium 1000 having an image recorded thereon is accommodated in the winding portion 4000 (FIG. 1). The recording medium 1000, which has passed through the first heating portion 2000 and the first cooling portion 3000 after recording is performed in the first recording portion 1100 and which has passed through the second heating portion 2300 and the second cooling portion 3300 after recording is performed in the second recording portion 1200, is conveyed while being supported by the support members 4100. The recording medium 1000 is finally accommodated in a state of being wound up into a roll shape by the winding device 4200. In order, for example, to accommodate respective different recorded products, the two or more winding devices 4200 may be provided.

(Recording Method)

As described above, an image is recorded by applying a reaction liquid and an ink to a recording medium while conveying the recording medium. The interval (time difference) between the application of the reaction liquid to the recording medium in the reaction liquid applying step and the application of the ink to the recording medium (contact with the reaction liquid) in the ink applying step is preferably 3,000 msec or less, more preferably 2,500 msec or less. When the period of time from the application of the reaction liquid to the contact of the ink with the reaction liquid is set within 3,000 msec, the evaporation amount of a liquid component such as water in the reaction liquid is reduced to suppress the precipitation of the reactant, and satisfactory reactivity can be maintained. Thus, the uniformity of an image can be improved. The interval (time difference) between the application of the reaction liquid to the recording medium in the reaction liquid applying step and the application of the ink to the recording medium (contact with the reaction liquid) in the ink applying step is preferably 100 msec or more. When a plurality of inks are used as the inks (first inks or second inks) to be used together with the reaction liquid, the above-mentioned interval is an interval for the ink that is first applied to the recording medium after the reaction liquid.

When a plurality of inks (first inks or second inks) are used as the inks to be used together with the reaction liquid, the interval for the plurality of inks applied from each of a plurality of adjacent second heads is set to preferably 50 msec or more. When the interval is set to 50 msec or more, the ink applied first starts reacting with the reaction liquid before the ink applied later is brought into contact with the reaction liquid, and hence mixing between the inks can be suppressed. Thus, the uniformity of an image can be further improved. The above-mentioned interval is set to preferably 500 msec or less. In addition, the interval (time difference) between the application of the ink that is first applied to the recording medium after the reaction liquid and the application of the ink that is last applied among the plurality of inks is set to preferably 2,500 msec or less. When the interval is set to 2,500 msec or less, the ink applied last among the plurality of inks also sufficiently reacts with the reaction liquid, and thus the uniformity of the image can be further improved. The above-mentioned interval is set to preferably 100 msec or more. Those intervals (time differences) are not set across the ink applied in the first recording portion and the ink applied in the second recording portion, but are set between the reaction liquid and the ink applied in each of the recording portions.

Regarding the application amounts of the reaction liquid and the ink to a unit region of the recording medium, the application amount of the ink to the unit region of the recording medium is preferably larger than the application amount of the reaction liquid to the unit region of the recording medium by mass. When the plurality of inks are used as the inks (first inks or second inks) to be used together with the reaction liquid, the ink application amount refers to the total application amount of the respective inks in one recording portion (corresponding to the plurality of inks in each recording portion when there are the first recording portion and the second recording portion). The application amount of the ink to the recording medium is more preferably 2.0 times or more, and is also preferably 15.0 times or less in terms of mass ratio to the application amount of the reaction liquid to the recording medium. When the application amount of the ink is larger than that of the reaction liquid, the temperature of liquid droplets as a whole after the contact between the reaction liquid and the ink is influenced by the temperature of the ink to be easily increased, and hence the diffusion of the reactant can be accelerated to enhance the reactivity. Thus, the uniformity of an image can be improved.

(Recording Medium)

As the recording medium, a low-absorbent recording medium having low aqueous ink absorbency or a non-absorbent recording medium having no aqueous ink absorbency is used. As used herein, the low-absorbent recording medium means a recording medium having a water absorption amount from contact start to 30 msec^{1/2} in a Bristow method of 5 mL/m² or more to 10 mL/m² or less. In addition, the non-absorbent recording medium means a recording medium having a water absorption amount from contact start to 30 msec^{1/2} in the Bristow method of less than 5 mL/m². The Bristow method is a method that is widely used as a measurement method for the absorption amount of a liquid within a short period of time, and the method has also been adopted by Japan Technical Association of the Pulp and Paper Industry (JAPAN TAPPI). Details about a test method are described in “Paper and Paperboard-Liquid Absorbency Test Method-Bristow Method” in Standard No. 51 of “JAPAN TAPPI Pulp and Paper Test Method 2000 Edition.”

Examples of the low-absorbent recording medium include a recording medium free of an ink-receiving layer and a recording medium having a thin ink-receiving layer. Examples thereof include actual printing stock, such as art paper, high quality coating paper, medium quality coating paper, high quality light coating paper, medium quality light coating paper, fine coating paper and cast coating paper.

In addition, examples of the non-absorbent recording medium include a recording medium free of an ink-receiving layer and a recording medium having a thin ink-receiving layer. Examples thereof include a plastic film and a product obtained by coating the top of a substrate such as paper with plastic. Examples of the plastic include polyvinyl chloride, polyethylene terephthalate, polycarbonate, polystyrene, polyurethane, polyethylene and polypropylene. In addition, examples of the recording medium may include glass, metal and ceramic. In particular, the non-absorbent recording medium is preferably used. When a recording medium having a small water absorption amount is used, a liquid component such as water in the reaction liquid is not easily absorbed, and hence the precipitation of the reactant is less liable to proceed and satisfactory reactivity is maintained. Thus, the uniformity of an image can be improved. The lower limit of the water absorption amount of the recording medium from contact start to 30 msec^{1/2} in the Bristow method is 0 mL/m² or more.

The basis weight (g/m²) of the recording medium 1000 is preferably 30 g/m² or more to 500 g/m² or less, more preferably 50 g/m² or more to 450 g/m² or less. The shape of the recording medium 1000 may be, for example, a roll of paper obtained by winding a long recording medium.

<Reaction Liquid>

The recording method of the present invention includes a reaction liquid applying step to apply an aqueous reaction liquid, which contains a reactant that reacts with the aqueous ink, to the recording medium. Respective components to be used in the reaction liquid and the like are described in detail below.

[Reactant]

The reaction liquid is brought into contact with the ink to react with the ink, to thereby aggregate components (a resin, a surfactant, and a component having an anionic group such as a self-dispersible pigment) in the ink. The reaction liquid contains the reactant. When the reactant is present, at the time of contact between the ink and the reactant in the recording medium, the state of presence of the component having an anionic group in the ink is destabilized and hence the aggregation of the ink can be accelerated. The reaction liquid to be used in the recording method of the present invention contains a polyvalent metal salt as a reactant. The polyvalent metal salt is ionically dissociated into a polyvalent metal ion and an anion in the aqueous reaction liquid, and the polyvalent metal ion reacts with the aqueous ink.

[Polyvalent Metal Ion]

Examples of the polyvalent metal ion may include: divalent metal ions, such as Ca²⁺, Cu²⁺, Ni²⁺, Mg²⁺, Sr²⁺, Ba²⁺ and Zn²⁺; and trivalent metal ions, such as Fe³⁺, Cr³⁺, Y³⁺ and Al³⁺. One or two or more polyvalent metal ions may be incorporated into the reaction liquid. The water-soluble polyvalent metal salt (which may be a hydrate) composed of the polyvalent metal ion and an anion binding to each other may be used to incorporate the polyvalent metal ion into the reaction liquid. That is, the polyvalent metal salt that produce the polyvalent metal ion in the reaction liquid can be added to the reaction liquid. In the polyvalent metal salt, examples of such anion may include: inorganic anions, such as Cl⁻; Br⁻, I⁻, ClO⁻; ClO₂₋; ClO₃₋; ClO₄₋, NO₂₋; NO₃₋; SO₄²⁻; CO₃²⁻; HCO₃₋; PO₄³⁻, HPO₄²⁻and H₂PO₄⁻; and organic anions, such as HCOO; (COO⁻)₂, COOH(COO⁻), CH₃COO⁻, CH₃CH(OH)COO⁻; C₂H₄(COO⁻)₂, C₆H₅COO⁻, C₆H₄(COO⁻)₂ and CH₃SO₃⁻. One or two or more polyvalent metal salts may be incorporated into the reaction liquid.

Of the polyvalent metal salts, at least one kind selected from the group consisting of: an inorganic polyvalent metal salt; and a polyvalent metal salt of a monovalent organic acid is preferred. Those polyvalent metal salts each have a higher aggregation property as compared to other polyvalent metal salts such as a polyvalent metal salt of a divalent organic acid, and thus the uniformity of an image is further improved. Preferred examples of the inorganic polyvalent metal salt may include magnesium sulfate, barium nitrate, iron sulfate, aluminum sulfate, magnesium chloride, aluminum nitrate and calcium chloride. Preferred examples of the polyvalent metal salt of the monovalent organic acid may include calcium formate, calcium propionate and magnesium acetate.

When the water solubility of the polyvalent metal salt that generates a polyvalent metal ion is high, the reactivity tends to be increased because the polyvalent metal ion is efficiently generated. Accordingly, a reactant having a good balance between water solubility and reactivity is preferably used. The water solubility at 20° C. of the polyvalent metal salt that generates a polyvalent metal ion in the reaction liquid is 1% by mass or more to 50% by mass or less, preferably 8% by mass or more to 30% by mass or less. The water solubility (% by mass) at 20° C. of the polyvalent metal salt is defined as a mass g/100 g×100 (% by mass) of an anhydrous compound in 100 g of a saturated solution at a temperature of 20° C. When the water solubility of the polyvalent metal salt is 1% by mass or more, preferably 8% by mass or more, the reactant is less liable to be precipitated even when a liquid component such as water in the reaction liquid is evaporated before the contact with the ink, and hence satisfactory reactivity is obtained. Thus, the uniformity of an image is further improved, and the stickiness of the image can be more effectively suppressed. In addition, when the water solubility of the polyvalent metal salt is 50% by mass or less, preferably 30% by mass or less, a recorded product does not easily absorb moisture in air even when the recorded product is placed under high humidity, and hence the stickiness of the image can be more effectively suppressed. Of the polyvalent metal salts, magnesium sulfate is preferred because magnesium sulfate is a reactant having a good balance of the above-mentioned water solubility.

The polyvalent metal salt equivalent content (mass %) in the reaction liquid is preferably 0.1% by mass or more to 20.0% by mass or less with respect to the total mass of the reaction liquid. The above-mentioned content in terms of polyvalent metal salt is more preferably 0.4% by mass or more to 10.0% by mass or less. In this specification, when the polyvalent metal salt is a hydrate, the “content (% by mass) of the polyvalent metal salt” in the reaction liquid means the “content (% by mass) of the anhydride of the polyvalent metal salt” obtained by removing water serving as a hydrate.

In addition to the polyvalent metal ion, the reaction liquid may contain any other reactant as required. Examples of the other reactant may include: a cationic component such as a cationic resin; and an organic acid.

[Aqueous Medium]

The reaction liquid is an aqueous reaction liquid containing at least water as an aqueous medium. Examples of the aqueous medium to be used in the reaction liquid may include the same examples as those of an aqueous medium that can be incorporated into the ink to be described later. A water-soluble organic solvent to be described later that can be incorporated into the ink may be incorporated into the aqueous medium to be used in the reaction liquid.

The content (% by mass) of water in the reaction liquid is preferably 55.0% by mass or more, more preferably 75.0% by mass or more, particularly preferably 85.0% by mass or more with respect to the total mass of the reaction liquid. When the content of water in the reaction liquid is set to 75.0% by mass or more, the precipitation of the reactant is easily suppressed, and the reactivity is satisfactorily maintained. Thus, the uniformity of an image can be further improved. When a hydrate of a polyvalent metal salt is used as the polyvalent metal salt that generates a polyvalent metal ion, the content of water in the reaction liquid also includes water in the hydrate of the polyvalent metal salt. The content of water in the reaction liquid is preferably 99.9% by mass or less, more preferably 95.0% by mass or less.

The reaction liquid may contain a water-soluble organic solvent as an aqueous medium. The content (% by mass) of the water-soluble organic solvent in the reaction liquid is preferably 40.0% by mass or less with respect to the total mass of the reaction liquid. In addition, when the reaction liquid contains a water-soluble organic solvent, the above-mentioned content of the water-soluble organic solvent in the reaction liquid is more preferably 1.0% by mass or more to 20.0% by mass or less, still more preferably 3.0% by mass or more to 12.0% by mass or less.

Solvents that may be used in an ink for ink jet, such as alcohols, (poly)alkylene glycols, glycol ethers, nitrogen-containing compounds and sulfur-containing compounds, may each be used as the water-soluble organic solvent. The reaction liquid preferably contains any one of alkanediols. The reaction liquid preferably contains at least one kind of water-soluble organic solvent selected from the group consisting of: 1,2-propanediol; 1,2-butanediol; 1,2-hexanediol; 1,3-butanediol; 1,4-butanediol; and 2,3-butanediol out of those solvents. Those alkanediols can further improve the uniformity of an image because of the following reason: the viscosity of the reaction liquid is not easily increased even when a liquid component such as water in the reaction liquid is evaporated, and hence the reaction liquid is easily mixed with the ink when being brought into contact therewith; and thus the diffusion of the reactant is facilitated to enhance the reactivity. It is particularly preferred that the reaction liquid be free of any water-soluble organic solvent other than the above-mentioned alkanediols.

In addition, when the boiling point of the water-soluble organic solvent is too high, the water-soluble organic solvent is not sufficiently evaporated in the heating step and remains in an image to cause stickiness in the image in some cases. Thus, the boiling point of the water-soluble organic solvent to be incorporated into the reaction liquid is preferably 150° C. or more to 280° C. or less.

(Surfactant)

The reaction liquid may contain various surfactants. Examples of the surfactants may include: a hydrocarbon-based surfactant; a fluorine-based surfactant; and a silicone-based surfactant. One kind or two or more kinds of those surfactants may be incorporated into the reaction liquid. Those surfactants may be any one of a nonionic surfactant, an anionic surfactant, a cationic surfactant or an amphoteric surfactant. The reaction liquid preferably contains a hydrocarbon-based surfactant. The surface tension of the reaction liquid in the case of the hydrocarbon-based surfactant is not easily decreased as compared to a fluorine-based surfactant and a silicone-based surfactant when the surfactants are used at the same content. Thus, even when a liquid component such as water in the reaction liquid is evaporated by the time when the reaction liquid is brought into contact with the ink, the surface tension is not easily decreased. Then, the reaction liquid containing water tends to remain on the surface of the recording medium to suppress the precipitation of the reactant, and satisfactory reactivity can be maintained. Thus, the uniformity of an image can be further improved. The content (% by mass) of the surfactant in the reaction liquid is preferably 0.01% by mass or more to 5.0% by mass or less with respect to the total mass of the reaction liquid.

[Other Component]

The reaction liquid may contain various other components as required. Examples of the other components may include the same examples as those of other components that can be incorporated into the ink to be described later.

[Physical Properties of Reaction Liquid]

The reaction liquid is an aqueous reaction liquid to be applied to an ink jet system. Accordingly, from the viewpoint of reliability, it is preferred that the physical property values of the reaction liquid be appropriately controlled. Specifically, the surface tension of the reaction liquid at 25° C. is preferably 20 mN/m or more, more preferably 27 mN/m or more, and is preferably 60 mN/m or less, more preferably 50 mN/m or less. When the surface tension is set to 27 mN/m or more, the reaction liquid containing water easily remains on the recording medium to suppress the precipitation of the reactant, and satisfactory reactivity is maintained. Thus, the uniformity of an image can be further improved. In addition, when the surface area in which the liquid droplets of the reaction liquid applied to the recording medium are brought into contact with air is reduced to suppress the evaporation of a liquid component such as water, to thereby suppress the precipitation of the reactant, satisfactory reactivity is maintained, and the uniformity of the image can be further improved. The surface tension of the reaction liquid can be measured by the platinum plate method.

In addition, the viscosity of the reaction liquid at 25° C. is preferably 1.0 mPa·s or more, and is preferably 10.0 mPa·s or less, more preferably 3.0 mPa·s or less. When the viscosity of the reaction liquid is 3.0 mPa·s or less, the reaction liquid and the ink are easily mixed with each other when the reaction liquid is brought into contact with the ink. Accordingly, the diffusion of the reactant can be facilitated to enhance the reactivity. Thus, the uniformity of the image can be further improved. The viscosity of the reaction liquid can be measured by a rotary viscometer. The pH of the reaction liquid at 25° C. is preferably 5.0 or more to 9.5 or less, more preferably 7.0 or more to 9.5 or less, still more preferably 8.0 or more to 9.5 or less.

<Ink>

The ink to be used in the recording method of the present invention is an aqueous ink for ink jet that preferably contains the pigment as the coloring material. Respective components to be used in the ink and the like are described in detail below.

[Coloring Material]

The ink preferably contains the pigment as the coloring material. The ink may further contain a dye as the coloring material. The ink may contain one or more of the coloring materials. The content (% by mass) of the coloring material in the ink is preferably 0.5% by mass or more to 15.0% by mass or less, more preferably 1.0% by mass or more to 10.0% by mass or less with respect to the total mass of the ink.

Specific examples of the pigment may include: inorganic pigments, such as carbon black and titanium oxide; and organic pigments, such as azo, phthalocyanine, quinacridone, isoindolinone, imidazolone, diketopyrrolopyrrole and dioxazine pigments. The pigments may be used alone or in combination thereof.

A resin-dispersed pigment using a resin as a dispersant, a self-dispersible pigment, which has a hydrophilic group bonded to its particle surface, or the like may be used as a dispersion system for the pigment. In addition, a resin-bonded pigment having a resin-containing organic group chemically bonded to its particle surface, a microcapsule pigment, which contains a particle whose surface is covered with, for example, a resin, or the like may be used. Pigments different from each other in dispersion system out of those pigments may be used in combination. Of those, not a resin-bonded pigment or a microcapsule pigment but a resin-dispersed pigment having a resin serving as a dispersant, the resin being caused to physically adsorb to its particle surface, is preferably used.

A dispersant that can disperse the pigment in an aqueous medium through the action of an anionic group is preferably used as a resin dispersant for dispersing the pigment in the aqueous medium. A resin having an anionic group may be used as the resin dispersant and such a resin as described later, in particular, a water-soluble resin is preferably used. The mass ratio of the content (% by mass) of the pigment in the ink to the content (% by mass) of the resin dispersant therein is preferably 0.3 times or more to 10.0 times or less.

As the self-dispersible pigment, a pigment in which an anionic group is bonded to the particle surface of the pigment directly or through any other atomic group (-R-) may be used. Specific examples of the other atomic group (-R-) may include: a linear or branched alkylene group having 1 to 12 carbon atoms; an arylene group, such as a phenylene group or a naphthylene group; a carbonyl group; an imino group; an amide group; a sulfonyl group; an ester group; and an ether group. In addition, groups obtained by combining those groups may be adopted.

A dye having an anionic group is preferably used as the dye. Specific examples of the dye may include dyes, such as azo, triphenylmethane, (aza)phthalocyanine, xanthene and anthrapyridone dyes.

Examples of the anionic group mentioned in the description of the resin dispersant, the self-dispersible pigment and the dye may include a carboxylic acid group, a sulfonic acid group and a phosphonic acid group. The anionic group may be any one of an acid type or a salt type. When the group is a salt type, the group may be in any one of a state in which part of the group is dissociated or a state in which the entirety thereof is dissociated. When the anionic group is a salt type, a cation serving as a counterion may be, for example, an alkali metal cation; ammonium or an organic ammonium. The coloring material to be incorporated into the ink is preferably a pigment, more preferably a resin-dispersed pigment or a self-dispersible pigment.

[Resin]

A resin may be incorporated into the ink. The use of the ink including the resin can record an image improved in abrasion resistance. The resin may be added to the ink (i) for stabilizing the dispersed state of the pigment, that is, as a resin dispersant or an aid therefor. In addition, the resin may be added to the ink (ii) for improving the various characteristics of an image to be recorded.

The content (% by mass) of the resin in the ink is preferably 0.1% by mass or more to 20.0% by mass or less, more preferably 0.5% by mass or more to 15.0% by mass or less with respect to the total mass of the ink. Examples of the form of the resin may include a block copolymer, a random copolymer, a graft copolymer and a combination thereof. In addition, the resin may be a water-soluble resin that can be dissolved in an aqueous medium or may be a resin particle to be dispersed in the aqueous medium. The resins may be used alone or in combination thereof.

[Composition of Resin]

Examples of the resin may include an acrylic resin, a urethane-based resin and an olefin-based resin. Of those, an acrylic resin and a urethane-based resin are preferred and an acrylic resin including a unit derived from (meth)acrylic acid or a (meth)acrylate is more preferred.

A resin having a hydrophilic unit and a hydrophobic unit as its structural units is preferred as the acrylic resin. Of those, a resin having a hydrophilic unit derived from (meth)acrylic acid and a hydrophobic unit derived from at least one of a monomer having an aromatic ring and a (meth)acrylic acid ester-based monomer is preferred. A resin having a hydrophilic unit derived from (meth)acrylic acid and a hydrophobic unit derived from at least one monomer of styrene and a-methylstyrene is particularly preferred. Those resins may each be suitably utilized as a resin dispersant for dispersing the pigment because the resins each easily cause an interaction with the pigment.

The hydrophilic unit is a unit having a hydrophilic group such as an anionic group. The hydrophilic unit may be formed by, for example, polymerizing a hydrophilic monomer having a hydrophilic group. Specific examples of the hydrophilic monomer having a hydrophilic group may include: acidic monomers each having a carboxylic acid group, such as (meth)acrylic acid, itaconic acid, maleic acid and fumaric acid; and anionic monomers, such as anhydrides and salts of these acidic monomers. A cation for forming the salt of the acidic monomer may be, for example, a lithium, sodium, potassium, ammonium or organic ammonium ion. The hydrophobic unit is a unit free of a hydrophilic group such as an anionic group. The hydrophobic unit may be formed by, for example, polymerizing the hydrophobic monomer free of a hydrophilic group such as anionic group. Specific examples of the hydrophobic monomer may include: monomers each having an aromatic ring, such as styrene, a-methylstyrene and benzyl (meth)acrylate; and (meth)acrylic acid ester-based monomers, such as methyl (meth)acrylate, butyl (meth)acrylate and 2-ethylhexyl (meth)acrylate.

The urethane-based resin may be obtained by, for example, causing a polyisocyanate and a polyol to react with each other. In addition, a chain extender may be further caused to react with the reaction product. Examples of the olefin-based resin may include polyethylene and polypropylene.

[Properties of Resin]

The phrase “resin is water-soluble” as used herein means that when the resin is neutralized with an alkali whose amount is equivalent to its acid value, the resin is present in an aqueous medium under a state in which the resin does not form any particle whose particle diameter may be measured by a dynamic light scattering method. Whether or not the resin is water-soluble can be judged in accordance with the following method. First, a liquid (resin solid content: 10% by mass) containing the resin neutralized with an alkali (e.g., sodium hydroxide or potassium hydroxide) corresponding to its acid value is prepared. Next, the prepared liquid is diluted with pure water tenfold (on a volume basis) to prepare a sample solution. Then, when no particle having a particle diameter is measured at the time of the measurement of the particle diameter of the resin in the sample solution by the dynamic light scattering method, the resin can be judged to be water-soluble. Measurement conditions at this time may be set, for example, as follows: SetZero: 30 seconds; number of times of measurement: 3; and measurement time: 180 seconds. In addition, a particle size analyzer based on the dynamic light scattering method (e.g., an analyzer available under the product name “UPA-EX150” from Nikkiso Co., Ltd.) or the like may be used as a particle size distribution measuring device. Of course, the particle size distribution measuring device to be used, the measurement conditions and the like are not limited to the foregoing.

The acid value of the water-soluble resin is preferably 100 mgKOH/g or more to 250 mgKOH/g or less. The weight-average molecular weight of the water-soluble resin is preferably 3,000 or more to 15,000 or less.

The acid value of a resin for forming the resin particle is preferably 5 mgKOH/g or more to 100 mgKOH/g or less. The weight-average molecular weight of the resin for forming the resin particle is preferably 1,000 or more to 3,000,000 or less, more preferably 100,000 or more to 3,000,000 or less. The volume-based 50% cumulative particle diameter (D50) of the resin particle measured by a dynamic light scattering method is preferably 50 nm or more to 500 nm or less. The volume-based 50% cumulative particle diameter of the resin particle is the diameter of the particle in a particle diameter cumulative curve at which the ratio of the particle integrated from small particle diameters reaches 50% with respect to the total volume of the measured particle. The volume-based 50% cumulative particle diameter of the resin particle may be measured with the above-mentioned particle size analyzer of a dynamic light scattering system and under the above-mentioned measurement conditions. The glass transition temperature of the resin particle is preferably 40° C. or more to 120° C. or less, more preferably 50° C. or more to 100° C. or less. The glass transition temperature (C) of the resin particle may be measured with a differential scanning calorimeter (DSC). The resin particle does not need to include any coloring material.

[Wax Particle]

A particle formed of a wax (wax particle) may be incorporated into the ink. The use of the ink including the wax particle can record an image further improved in abrasion resistance. The wax in this specification may be a composition blended with a component except the wax or may be the wax itself. The wax particle may be dispersed with a dispersant, such as a surfactant or a resin. The waxes may be used alone or in combination thereof. The content (% by mass) of the wax particle in the ink is preferably 0.1% by mass or more to 10.0% by mass or less, more preferably 1.0% by mass or more to 5.0% by mass or less with respect to the total mass of the ink.

The wax is an ester of a higher monohydric or dihydric alcohol that is insoluble in water and a fatty acid in a narrow sense. Accordingly, animal-based waxes and plant-based waxes are included in the category of the wax but oils and fats are not included therein. High-melting point fats, mineral-based waxes, petroleum-based waxes and blends and modified products of various waxes are included therein in a broad sense. In the present invention, the waxes in a broad sense may each be used without any particular limitation. The waxes in a broad sense may be classified into natural waxes, synthetic waxes, blends thereof (blended waxes) and modified products thereof (modified waxes).

Examples of the natural wax may include: animal-based waxes, such as beeswax, a spermaceti wax and lanolin; plant-based waxes, such as a Japan wax, a carnauba wax, a sugar cane wax, a palm wax, a candelilla wax and a rice wax; mineral-based waxes such as a montan wax; and petroleum-based waxes, such as a paraffin wax, a microcrystalline wax and petrolatum. Examples of the synthetic wax may include hydrocarbon-based waxes, such as a Fischer-Tropsch wax and polyolefin waxes (e.g., polyethylene wax and polypropylene wax). The blended waxes are mixtures of the above-mentioned various waxes. The modified waxes are obtained by subjecting the above-mentioned various waxes to modification treatment, such as oxidation, hydrogenation, alcohol modification, acrylic modification or urethane modification. The above-mentioned waxes may be used alone or in combination thereof. The wax is preferably at least one kind selected from the group consisting of: a microcrystalline wax; a Fischer-Tropsch wax; a polyolefin wax; a paraffin wax; and modified products and blends thereof. Of those, a blend of a plurality of kinds of waxes is more preferred and a blend of a petroleum-based wax and a synthetic wax is particularly preferred.

The wax is preferably a solid at normal temperature (25° C.). The melting point (° C.) of the wax is preferably 40° C. or more to 120° C. or less, more preferably 50° C. or more to 100° C. or less. The melting point of the wax may be measured in conformity with a test method described in the section 5.3.1 (Melting Point Testing Method) of JIS K 2235: 1991 (Petroleum Waxes). In the cases of a microcrystalline wax, petrolatum and a mixture of a plurality of kinds of waxes, their melting points may be measured with higher accuracy by utilizing a test method described in the section 5.3.2 thereof. The melting point of the wax is susceptible to characteristics, such as a molecular weight (a larger molecular weight provides a higher melting point), a molecular structure (a linear structure provides a higher melting point but a branched structure provides a lower melting point), crystallinity (higher crystallinity provides a higher melting point) and a density (a higher density provides a higher melting point). Accordingly, the control of those characteristics can provide a wax having a desired melting point. The melting point of the wax in the ink may be measured, for example, as follows: after the wax fractionated by subjecting the ink to ultracentrifugation treatment has been washed and dried, its melting point is measured in conformity with each of the above-mentioned test methods.

[Aqueous Medium]

The ink to be used in the recording method of the present invention is an aqueous ink including at least water as an aqueous medium. An aqueous medium that is the water or a mixed solvent of the water and a water-soluble organic solvent may be incorporated into the ink. Deionized water or ion-exchanged water is preferably used as the water. The content (% by mass) of the water in the aqueous ink is preferably 60.00% by mass or more to 95.00% by mass or less with respect to the total mass of the ink. In the case where the content of water in the ink is 60.0% by mass or more, even when the reactant in the reaction liquid is partially precipitated at a time of contact between the reaction liquid and the ink, the reactant is easily redissolved, and hence satisfactory reactivity can be maintained. Thus, the uniformity of an image can be further improved.

The content (% by mass) of the water-soluble organic solvent in the aqueous ink is preferably 3.0% by mass or more to 38.0% by mass or less with respect to the total mass of the ink. Solvents that may be used in an ink for ink jet, such as alcohols, (poly)alkylene glycols, glycol ethers, nitrogen-containing solvents and sulfur-containing solvents, may each be used as the water-soluble organic solvent. The water-soluble organic solvents may be used alone or in combination thereof.

[Other Component]

The ink may include various other components as required. Examples of other components may include various additives, such as an antifoaming agent, a surfactant, a pH adjustor, a viscosity modifier, a rust inhibitor, an antiseptic, a fungicide, an antioxidant and an anti-reducing agent. However, the ink is preferably free of the reactant to be incorporated into the reaction liquid.

[Physical Properties of Ink]

The ink is an aqueous ink to be applied to an ink jet system. Accordingly, from the viewpoint of reliability, it is preferred that the physical property values of the ink be appropriately controlled. Specifically, the surface tension of the ink at 25° C. is preferably 20 mN/m or more to 60 mN/m or less. The surface tension of the ink can be measured by the platinum plate method. In addition, the viscosity of the ink at 25° C. is preferably 1.0 mPa·s or more to 10.0 mPa·s or less. The viscosity of the ink can be measured by a rotary viscometer. The pH of the ink at 25° C. is preferably 7.0 or more to 9.5 or less, more preferably 8.0 or more to 9.5 or less.

### EXAMPLES

The present invention is described in more detail below by way of Examples and Comparative Examples. The present invention is by no means limited to Examples below without departing from the gist of the present invention. “Part(s)” and “%” with regard to the description of the amounts of components are by mass unless otherwise stated.

<Preparation of Reaction Liquid>

Respective components (unit: %) shown in Table 1 (Table 1-1 to Table 1-4) were mixed and sufficiently stirred, followed by filtration with a cellulose acetate filter having a pore size of 3.0 μm (manufactured by Advantec) under pressure. Thus, respective reaction liquids were prepared. The terms “Acetylenol E40” and “Acetylenol E100” shown in Table 1 are the product names of an acetylene glycol ethylene oxide adduct that is a hydrocarbon-based surfactant manufactured by Kawaken Fine Chemicals Co., Ltd. (the same also applies to Table 2 described later). The terms “BYK-3420” and “BYK-348” are the product names of a silicone-based surfactant manufactured by BYK-Chemie GmbH. The content (%) of water in each of the reaction liquids, the water solubility (%) at 20° C. of a polyvalent metal salt, and the surface tension (mN/m) and viscosity (mPa·s) at 25° C. of the reaction liquid are shown as the characteristics of the reaction liquid in the lower part of Table 1. The surface tension of the reaction liquid was measured by a platinum plate method using an automatic surface tension meter (DY-300 type, manufactured by Kyowa Interfacial Science Co., Ltd.). The viscosity of the reaction liquid was measured using an E-type viscometer (trade name “RE-85L”, manufactured by Toki Sangyo Co., Ltd.) under the conditions of a temperature of 25° C. and 50 rpm. The content of water in the reaction liquid is a value including water derived from a hydrate of the polyvalent metal salt.

Table 1-1

Composition and property of the reaction liquids

TABLE 1-2

| | Reaction liquid | | | | | | | | | |
|---|---|---|---|---|---|---|---|---|---|---|
| | 1 | 2 | 3 | 4 | 5 | 6 | 7 | 8 | 9 | 10 |
| Calcium sulfate dihydrate (Solubility in | | | | | | | | | | |
| water: 0.2%) | | | | | | | | | | |
| Calcium succinate trihydrate (Solubility in | | | | | | | | | | |
| water: 1.3%) | | | | | | | | | | |
| Barium nitrate (Solubility in water: 8%) | | | | | | | | | | |
| Calcium formate (Solubility in water: 17%) | | | | | | | | | | |
| Iron sulfate heptahydrate (Solubility in | | | | | | | | | | |
| water: 21%) | | | | | | | | | | |
| Magnesium sulfate heptahydrate (Solubility | 8.0 | 0.8 | 8.0 | 8.0 | 8.0 | 8.0 | 8.0 | 8.0 | 8.0 | 8.0 |
| in water: 25%) | | | | | | | | | | |
| Aluminum sulfate hexadeca-hydrate | | | | | | | | | | |
| (Solubility in water: 28%) | | | | | | | | | | |
| Calcium propionate (Solubility in water: | | | | | | | | | | |
| 29%) | | | | | | | | | | |
| Magnesium acetate tetrahydrate (Solubility | | | | | | | | | | |
| in water: 32%) | | | | | | | | | | |
| Magnesium chloride hexahydrate | | | | | | | | | | |
| (Solubility in water: 35%) | | | | | | | | | | |
| Aluminum nitrate nonahydrate (Solubility in | | | | | | | | | | |
| water: 43%) | | | | | | | | | | |
| Calcium chloride hexahydrate (Solubility in | | | | | | | | | | |
| water: 43%) | | | | | | | | | | |
| Calcium nitrate tetrahydrate (Solubility in | | | | | | | | | | |
| water: 56%) | | | | | | | | | | |
| 1,2-Propanediol | 6.0 | 6.0 | 22.0 | 21.0 | 12.0 | 11.0 | 1.0 | | | 6.0 |
| 1,3-Butanediol | | | | | | | | | | |
| 1,2-Hexanediol | | | | | | | | 10.0 | 10.0 | |
| Glycerin | | | | | | | | | | |
| 2-Pyrrolidone | | | | | | | | | | |
| Trimethylolpropane | | | | | | | | | | |
| Acetylenol E100 | 0.1 | 0.1 | 0.1 | 0.1 | 0.1 | 0.1 | 0.1 | | 1.0 | 1.0 |
| Acetylenol E40 | | | | | | | | 1.0 | | |
| BYK-3420 | | | | | | | | | | |
| BYK-348 | | | | | | | | | | |
| Ion-exchanged water | 85.9 | 93.1 | 69.9 | 70.9 | 79.9 | 80.9 | 90.9 | 81.0 | 81.0 | 85.0 |
| Water content in reaction liquid (%) | 90.0 | 93.5 | 74.0 | 75.0 | 84.0 | 85.0 | 95.0 | 85.1 | 85.1 | 89.1 |
| Solubility of polyvalent metal salts in water | 25 | 25 | 25 | 25 | 25 | 25 | 25 | 25 | 25 | 25 |
| (%) | | | | | | | | | | |
| Surface tension (mN/m) | 34 | 34 | 35 | 35 | 34 | 34 | 34 | 26 | 27 | 28 |
| Viscosity (mPa · s) | 1.5 | 1.1 | 2.7 | 2.5 | 1.8 | 1.7 | 1.2 | 1.9 | 1.9 | 1.5 |

Composition and property of the reaction liquids

TABLE 1-3

| | Reaction liquid | | | | | | | | | |
|---|---|---|---|---|---|---|---|---|---|---|
| | 11 | 12 | 13 | 14 | 15 | 16 | 17 | 18 | 19 | 20 |
| Calcium sulfate dihydrate (Solubility in | | | | | | | | | | |
| water: 0.2%) | | | | | | | | | | |
| Calcium succinate trihydrate (Solubility in | | | | | | | | | | |
| water: 1.3%) | | | | | | | | | | |
| Barium nitrate (Solubility in water: 8%) | | | | | | | | | | |
| Calcium formate (Solubility in water: 17%) | | | | | | | | | | |
| Iron sulfate heptahydrate (Solubility in | | | | | | | | | | |
| water: 21%) | | | | | | | | | | |
| Magnesium sulfate heptahydrate | 8.0 | 8.0 | 8.0 | 8.0 | 6.0 | 8.0 | 8.0 | 8.0 | 8.0 | 8.0 |
| (Solubility in water: 25%) | | | | | | | | | | |
| Aluminum sulfate hexadeca-hydrate | | | | | | | | | | |
| (Solubility in water: 28%) | | | | | | | | | | |
| Calcium propionate (Solubility in water: | | | | | | | | | | |
| 29%) | | | | | | | | | | |
| Magnesium acetate tetrahydrate (Solubility | | | | | | | | | | |
| in water: 32%) | | | | | | | | | | |
| Magnesium chloride hexahydrate | | | | | | | | | | |
| (Solubility in water: 35%) | | | | | | | | | | |
| Aluminum nitrate nonahydrate (Solubility in | | | | | | | | | | |
| water: 43%) | | | | | | | | | | |
| Calcium chloride hexahydrate (Solubility in | | | | | | | | | | |
| water: 43%) | | | | | | | | | | |
| Calcium nitrate tetrahydrate (Solubility in | | | | | | | | | | |
| water: 56%) | | | | | | | | | | |
| 1,2-Propanediol | 6.0 | 6.0 | 6.0 | 6.0 | 1.0 | 24.0 | 30.0 | | | |
| 1,3-Butanediol | | | | | | | | 6.0 | | |
| 1,2-Hexanediol | | | | | | | | | 6.0 | |
| Glycerin | | | | | | | | | | 6.0 |
| 2-Pyrrolidone | | | | | | | | | | |
| Trimethylolpropane | | | | | | | | | | |
| Acetylenol E100 | 0.3 | 0.2 | 0.01 | | 0.1 | 0.1 | 0.3 | 0.1 | 0.1 | 0.1 |
| Acetylenol E40 | | | | | | | | | | |
| BYK-3420 | | | | 0.03 | | | | | | |
| BYK-348 | | | | | | | | | | |
| Ion-exchanged water | 85.7 | 85.8 | 85.99 | 85.97 | 92.9 | 67.9 | 61.7 | 85.9 | 85.9 | 85.9 |
| Water content in reaction liquid (%) | 89.8 | 89.9 | 90.1 | 90.1 | 96.0 | 72.0 | 65.8 | 90.0 | 90.0 | 90.0 |
| Solubility of polyvalent metal salts in water | 25 | 25 | 25 | 25 | 25 | 25 | 25 | 25 | 25 | 25 |
| (%) | | | | | | | | | | |
| Surface tension (mN/m) | 29 | 30 | 45 | 28 | 35 | 35 | 34 | 34 | 34 | 34 |
| Viscosity (mPa · s) | 1.5 | 1.5 | 1.4 | 1.5 | 1.0 | 3.0 | 3.8 | 1.5 | 1.5 | 1.5 |

Composition and property of the reaction liquids

TABLE 1-4

| | Reaction liquid | | | | | | | | | |
|---|---|---|---|---|---|---|---|---|---|---|
| | 21 | 22 | 23 | 24 | 25 | 26 | 27 | 28 | 29 | 30 |
| Calcium sulfate dihydrate (Solubility in | | | | | | | | | | |
| water: 0.2%) | | | | | | | | | | |
| Calcium succinate trihydrate (Solubility in | | | 1.1 | | | | | | | |
| water: 1.3%) | | | | | | | | | | |
| Barium nitrate (Solubility in water: 8%) | | | | 4.0 | | | | | | |
| Calcium formate (Solubility in water: 17%) | | | | | 4.0 | | | | | |
| Iron sulfate heptahydrate (Solubility in | | | | | | 7.4 | | | | |
| water: 21%) | | | | | | | | | | |
| Magnesium sulfate heptahydrate | 8.0 | 8.0 | | | | | | | | |
| (Solubility in water: 25%) | | | | | | | | | | |
| Aluminum sulfate hexadeca-hydrate | | | | | | | 7.4 | | | |
| (Solubility in water: 28%) | | | | | | | | | | |
| Calcium propionate (Solubility in water: | | | | | | | | 4.0 | | |
| 29%) | | | | | | | | | | |
| Magnesium acetate tetrahydrate (Solubility | | | | | | | | | 6.0 | |
| in water: 32%) | | | | | | | | | | |
| Magnesium chloride hexahydrate | | | | | | | | | | 8.5 |
| (Solubility in water: 35%) | | | | | | | | | | |
| Aluminum nitrate nonahydrate (Solubility in | | | | | | | | | | |
| water: 43%) | | | | | | | | | | |
| Calcium chloride hexahydrate (Solubility | | | | | | | | | | |
| in water: 43%) | | | | | | | | | | |
| Calcium nitrate tetrahydrate (Solubility in | | | | | | | | | | |
| water: 56%) | | | | | | | | | | |
| 1,2-Propanediol | | | 6.0 | 6.0 | 6.0 | 6.0 | 6.0 | 6.0 | 6.0 | 6.0 |
| 1,3-Butanediol | | | | | | | | | | |
| 1,2-Hexanediol | | | | | | | | | | |
| Glycerin | | | | | | | | | | |
| 2-Pyrrolidone | 6.0 | | | | | | | | | |
| Trimethylolpropane | | 6.0 | | | | | | | | |
| Acetylenol E100 | 0.1 | 0.1 | 0.1 | 0.1 | 0.1 | 0.1 | 0.1 | 0.1 | 0.1 | 0.1 |
| Acetylenol E40 | | | | | | | | | | |
| BYK-3420 | | | | | | | | | | |
| BYK-348 | | | | | | | | | | |
| Ion-exchanged water | 85.9 | 85.9 | 92.8 | 89.9 | 89.9 | 86.5 | 86.5 | 89.9 | 87.9 | 85.4 |
| Water content in reaction liquid (%) | 90.0 | 90.0 | 93.1 | 89.9 | 89.9 | 89.9 | 89.9 | 89.9 | 89.9 | 89.9 |
| Solubility of polyvalent metal salts in water | 25 | 25 | 1.3 | 8 | 17 | 21 | 28 | 29 | 32 | 35 |
| (%) | | | | | | | | | | |
| Surface tension (mN/m) | 34 | 34 | 34 | 34 | 34 | 34 | 34 | 34 | 34 | 34 |
| Viscosity (mPa · s) | 1.5 | 1.5 | 1.1 | 1.5 | 1.5 | 1.5 | 1.5 | 1.5 | 1.5 | 1.5 |

Composition and property of the reaction liquids

| | Reaction liquid | | | | | | | | |
|---|---|---|---|---|---|---|---|---|---|
| | 31 | 32 | 33 | 34 | 35 | 36 | 37 | 38 | 39 |
| Calcium sulfate dihydrate (Solubility in | | | | | | 0.2 | | | |
| water: 0.2%) | | | | | | | | | |
| Calcium succinate trihydrate (Solubility in | | | | | 0.6 | | | | |
| water: 1.3%) | | | | | | | | | |
| Barium nitrate (Solubility in water: 8%) | | | | | | | | | |
| Calcium formate (Solubility in water: 17%) | | | | | | | | | |
| Iron sulfate heptahydrate (Solubility in | | | | | | | | | |
| water: 21%) | | | | | | | | | |
| Magnesium sulfate heptahydrate | | | 0.9 | 1.6 | | | | | 4.0 |
| (Solubility in water: 25%) | | | | | | | | | |
| Aluminum sulfate hexadeca-hydrate | | | | | | | | | |
| (Solubility in water: 28%) | | | | | | | | | |
| Calcium propionate (Solubility in water: | | | | | | | | | |
| 29%) | | | | | | | | | |
| Magnesium acetate tetrahydrate (Solubility | | | | | | | | | |
| in water: 32%) | | | | | | | | | |
| Magnesium chloride hexahydrate | | | | | | | | | |
| (Solubility in water: 35%) | | | | | | | | | |
| Aluminum nitrate nonahydrate (Solubility in | 7.0 | | | | | | | | |
| water: 43%) | | | | | | | | | |
| Calcium chloride hexahydrate (Solubility in | | 7.8 | | | | | | | |
| water: 43%) | | | | | | | | | |
| Calcium nitrate tetrahydrate (Solubility in | | | | | | | 5.8 | 10.0 | |
| water: 56%) | | | | | | | | | |
| 1,2-Propanediol | 6.0 | 6.0 | 6.0 | 6.0 | | 6.0 | 6.0 | | |
| 1,3-Butanediol | | | | | | | | | 5.0 |
| 1,2-Hexanediol | | | | | | | | | 5.0 |
| Glycerin | | | | | 38.0 | | | 2.0 | |
| 2-Pyrrolidone | | | | | | | | 3.0 | 15.0 |
| Trimethylolpropane | | | | | | | | 10.0 | |
| Acetylenol E100 | 0.1 | 0.1 | 0.1 | 0.1 | | 0.1 | 0.1 | 0.6 | |
| Acetylenol E40 | | | | | | | | | |
| BYK-3420 | | | | | | | | | |
| BYK-348 | | | | | 0.1 | | | | 2.0 |
| Ion-exchanged water | 86.9 | 86.1 | 93.0 | 92.3 | 61.3 | 93.7 | 88.1 | 74.4 | 69.0 |
| Water content in reaction liquid (%) | 89.9 | 89.9 | 93.5 | 93.1 | 61.4 | 93.7 | 89.9 | 77.5 | 71.0 |
| Solubility of polyvalent metal salts in water | 43 | 43 | 25 | 25 | 1.3 | 0.2 | 56 | 56 | 25 |
| (%) | | | | | | | | | |
| Surface tension (mN/m) | 34 | 34 | 34 | 34 | 23 | 34 | 37 | 33 | 22 |
| Viscosity (mPa · s) | 1.5 | 1.5 | 1.1 | 1.2 | 3.5 | 1.0 | 1.3 | 1.9 | 2.7 |

<Preparation of Pigment Dispersion Liquid>

(Pigment Dispersion Liquid 1)

A styrene-ethyl acrylate-acrylic acid copolymer (resin 1) having an acid value of 150 mgKOH/g and a weight average molecular weight of 8,000 was prepared. 20.0 parts of the resin 1 was neutralized with potassium hydroxide equimolar to the acid value of the resin 1, and then an appropriate amount of pure water was added, whereby an aqueous solution of the resin 1 having a content of the resin (solid content) of 20.0% was prepared. 10.0 parts of a pigment (C.I. Pigment Blue 15:3), 15.0 parts of the aqueous solution of the resin 1 and 75.0 parts of pure water were mixed to obtain a mixture. The obtained mixture and 200 parts of zirconia beads having a diameter of 0.3 mm were put in a batch type vertical sand mill (manufactured by IMEX Co., Ltd.) and dispersed for 5 hours while cooling with water. After a coarse particle was removed by centrifugation, the mixture was filtered through a cellulose acetate filter having a pore size of 3.0 μm (manufactured by ADVANTEC CO., LTD.) under pressure to prepare a pigment dispersion liquid 1 having a content of the pigment of 10.0% and a content of the resin dispersant (resin 1) of 3.0%.

(Pigment Dispersion Liquid 2)

A pigment dispersion liquid 2 having a pigment content of 10.0% and a resin dispersant (Resin 1) content of 3.0% was prepared by the same procedure as that of the above-mentioned pigment dispersion liquid 1 except that the pigment was changed to C.I. Pigment Red 122.

(Pigment Dispersion Liquid 3)

A pigment dispersion liquid 3 having a pigment content of 10.0% and a resin dispersant (Resin 1) content of 3.0% was prepared by the same procedure as that of the above-mentioned pigment dispersion liquid 1 except that the pigment was changed to C.I. Pigment Yellow 74.

(Pigment Dispersion Liquid 4)

A pigment dispersion liquid 4 having a pigment content of 10.0% and a resin dispersant (Resin 1) content of 3.0% was prepared by the same procedure as that of the above-mentioned pigment dispersion liquid 1 except that the pigment was changed to carbon black.

(Pigment Dispersion Liquid 5)

A solution obtained by dissolving 5.0 g of concentrated hydrochloric acid in 5.5 g of water was brought into the state of being cooled to 5° C., followed by the addition of 1.5 g of 4-aminophthalic acid to the solution. A container containing the solution was loaded into an ice bath, and while the solution was stirred so that its temperature was held at 10° C. or less, a solution obtained by dissolving 0.9 g of sodium nitrite in 9.0 g of ion-exchanged water at 5° C. was added thereto. After the mixture had been stirred for 15 minutes, 6.0 g of carbon black was added to the mixture under stirring and the whole was further stirred for 15 minutes to provide a slurry. The resultant slurry was filtered with filter paper (product name: “STANDARD FILTER PAPER No. 2,” manufactured by Advantec), and particles remaining on the filter paper were sufficiently washed with water and dried in an oven at 110° C. After that, a sodium ion was substituted with a potassium ion by an ion exchange method. Thus, a self-dispersion pigment in which a —C₆H₃—(COOK)₂ group was bonded to the particle surface of the pigment was obtained. An appropriate amount of pure water was added to adjust the content of the pigment. Thus, a pigment dispersion liquid 5 in which the content of the pigment was 10.0% was obtained.

<Preparation of Resin Particle>

74.0 Parts of ion-exchanged water and 0.2 part of potassium persulfate were loaded into a four-necked flask including a stirrer, a reflux condenser and a nitrogen gas introduction pipe, followed by mixing. In addition, 24.0 parts of ethyl methacrylate, 1.5 parts of methacrylic acid and 0.3 part of a reactive surfactant (product name “ADEKA REASOAP ER-20”, manufactured by Adeka Corporation) were mixed to prepare an emulsion. Under a nitrogen atmosphere, the prepared emulsion was dropped into the above-mentioned four-necked flask over 1 hour and was subjected to a polymerization reaction for 2 hours while the mixture was stirred at 80° C. After the resultant had been cooled to 25° C., ion-exchanged water and an aqueous solution containing potassium hydroxide whose molar amount was equivalent to the acid value of a resin particle were added. Thus, a water dispersion liquid of the resin particle in which the content of the resin particle (solid content) was 40.0% was prepared.

<Preparation of Ink>

Respective components (unit: %) shown in Table 2 were mixed and sufficiently stirred, followed by filtration with a cellulose acetate filter having a pore size of 3.0 μm (manufactured by Advantec) under pressure. Thus, respective inks were prepared. The term “Acetylenol E100” shown in Table 2 is the product name of a surfactant manufactured by Kawaken Fine Chemicals Co., Ltd.

TABLE 2
Composition of the inks

| | Ink | | | | | | | |
|---|---|---|---|---|---|---|---|---|
| | 1 | 2 | 3 | 4 | 5 | 6 | 7 | 8 |
| Pigment dispersion | 40.0 | | | | | 40.0 | 40.0 | 40.0 |
| liquid 1 | | | | | | | | |
| Pigment dispersion | | 40.0 | | | | | | |
| liquid 2 | | | | | | | | |
| Pigment dispersion | | | 40.0 | | | | | |
| liquid 3 | | | | | | | | |
| Pigment dispersion | | | | 40.0 | | | | |
| liquid 4 | | | | | | | | |
| Pigment dispersion | | | | | 40.0 | | | |
| liquid 5 | | | | | | | | |
| Water dispersion | 25.0 | 25.0 | 25.0 | 25.0 | 25.0 | 25.0 | 25.0 | 25.0 |
| liquid of | | | | | | | | |
| Resin particle | | | | | | | | |
| 1,2-Butanediol | 15.0 | 15.0 | 15.0 | 15.0 | 15.0 | 25.0 | 24.3 | 4.0 |
| Acetylenol E100 | 0.5 | 0.5 | 0.5 | 0.5 | 0.5 | 0.5 | 0.5 | 0.5 |
| Ion-exchanged water | 19.5 | 19.5 | 19.5 | 19.5 | 19.5 | 9.5 | 10.2 | 30.5 |
| Water content in ink (%) | 69.3 | 69.3 | 69.3 | 69.3 | 70.5 | 59.3 | 60.0 | 80.3 |

<Preparation of Recording Medium>

The following recording mediums were prepared. The water absorption amount represents a water absorption amount from contact start to 30 msec^{1/2} in a Bristow method. The recording mediums 1 to 4 are each label paper including an adhesive layer and release paper on a back surface of a surface base material described below.

Recording medium 1 (non-absorbency, water absorption amount: less than 2.5 mL/m²): white polyester film (product name: “PETWH50(A)PAT1 8LK2”, manufactured by LINTEC Corporation)

Recording medium 2 (low absorbency, water absorption amount: less than 2.5 mL/m²): polyvinyl chloride film (product name: “Scotchcal Graphic Film IJ1220-10”, manufactured by 3M Company)

Recording medium 3 (low absorbency, water absorption amount: 5.5 mL/m²): coated paper [art paper] (product name: “Gloss PW8K”, manufactured by LINTEC Corporation)

Recording medium 4 (absorbent, water absorption amount: 10.2mL/m²): plain paper (product name: “High-grade 55 PW8K”, manufactured by LINTEC Corporation)

<Evaluation>

The recording conditions are shown in Table 3, and the evaluation conditions are shown in the left column of Table 4 (Table 4-1 and Table 4-2). Reaction liquids and inks of the kinds shown in the left column of Table 4 were combined to form sets of the inks and the reaction liquids. The reaction liquids and the inks for forming the sets were each filled into the second reaction liquid applying device 1202 and second ink applying device 1203 of the ink jet recording apparatus 100 having a configuration illustrated in FIG. 1. Each of the liquid applying devices is an ejection head of a system including ejecting a liquid through action of heat energy. An ink filling position in the second ink applying device 1203 was set to the second position from an upstream side in a conveyance direction of a recording medium. In addition, the distance between an ejection orifice surface of the ejection head and the recording medium was set to 1.0 mm. The reaction liquid and the ink were applied to the recording medium in the stated order by a one-pass system under the recording conditions and recording duty shown in Table 3 and the left column of Table 4 through use of the ink jet recording apparatus 100, to thereby record a solid image measuring 5 cm by 5 cm. In the ink jet recording apparatus 100 used in Examples of the present invention, an image recorded under the following conditions is defined as having a recording duty of 100%: one ink droplet having a mass of 3.0 ng is applied to a unit region measuring 1/1,200 inch by 1/1,200 inch. In Reference Examples 1 to 3, ink cartridges filled with the reaction liquids and inks of the kinds shown in Table 4 were each set in an ink jet recording apparatus (product name: “PIXUS PRO-10”, manufactured by Canon Inc.). The definition of the recording duty is the same as that in the case of the ink jet recording apparatus 100. The reaction liquid and the ink were applied to the recording medium by a multi-pass system under the recording conditions and recording duty shown in Table 3 and the left column of Table 4 through use of the above-mentioned apparatus, to thereby record a solid image measuring 5 cm by 5 cm.

In the left column of Table 3, the application amounts of each of the reaction liquids and each of the inks per unit area of the recording medium are shown as “Duty A (%) of reaction liquid” and “Duty B (%) of ink,” and “Value of B/A” is also shown. In addition, in the right column of Table 3, there are shown “Temperature (° C.) of reaction liquid at time of ejection” from a first ejection head of an ink jet system of the second reaction liquid applying device 1202 and “Temperature (C) of ink at time of ejection” from a second ejection head of an ink jet system of the second ink applying device 1203. Further, there are shown “Temperature (C) of recording medium” at a time of application of the reaction liquid and “Time difference (msec)” between the application of the reaction liquid to the recording medium and the application of the ink to the recording medium. When the ink filling position in the second ink applying device 1203 in the ink jet recording apparatus 100 is set to the second position from the upstream side in the conveyance direction of the recording medium, and the conveyance speed of the recording medium is set to 30 m/min, the above-mentioned time difference becomes 600 msec. When the time difference was made different from 600 msec, the time difference was set to a value shown in Table 3 by: fixing the ink filling position in the second ink applying device 1203 to the second position from the upstream side; and adjusting the conveyance speed of the recording medium.

In Examples of the present invention, in evaluation criteria for each of the following items, while ranks “AAA”, “AA”, “A”, and “B” were defined as acceptable levels, a rank “C” was defined as an unacceptable level. The evaluation results are shown on the right side of Table 4.

TABLE 3
Recording conditions

| | | | | Temperature | | | | |
|---|---|---|---|---|---|---|---|---|
| | Amount of applying | | | Temperature of | | | | |
| | Duty of | | | the reaction | Temperature of | Difference in | Temperature | |
| | reaction | Duty of | | liquid at the time | ink at the time of | temperature | of recording | Time |
| Recording | liquid | ink | Value of | of ejecting | ejecting | Ti − | medium | difference |
| condition | A(%) | B(%) | B/A | Tr(° C.) | Ti(° C.) | Tr(° C.) | (° C.) | (msec) |
| 1 | 10 | 100 | 10.0 | 35 | 50 | 15 | 30 | 600 |
| 2 | 100 | 100 | 1.0 | 35 | 50 | 15 | 30 | 600 |
| 3 | 13 | 100 | 7.7 | 35 | 50 | 15 | 30 | 600 |
| 4 | 50 | 100 | 2.0 | 35 | 50 | 15 | 30 | 600 |
| 5 | 10 | 100 | 10.0 | 35 | 50 | 15 | 40 | 600 |
| 6 | 10 | 100 | 10.0 | 35 | 50 | 15 | 35 | 600 |
| 7 | 10 | 100 | 10.0 | 35 | 50 | 15 | 30 | 100 |
| 8 | 10 | 100 | 10.0 | 35 | 50 | 15 | 30 | 3000 |
| 9 | 10 | 100 | 10.0 | 35 | 50 | 15 | 30 | 3100 |
| 10 | 10 | 100 | 10.0 | 40 | 41 | 1 | 30 | 600 |
| 11 | 10 | 100 | 10.0 | 40 | 45 | 5 | 30 | 600 |
| 12 | 10 | 100 | 10.0 | 35 | 55 | 20 | 30 | 600 |
| 13 | 10 | 100 | 10.0 | 25 | 55 | 30 | 25 | 600 |
| 14 | 10 | 100 | 10.0 | 45 | 55 | 10 | 30 | 600 |
| 15 | 10 | 100 | 10.0 | 50 | 55 | 5 | 30 | 600 |
| 16 | 92 | 100 | 1.1 | 35 | 50 | 15 | 30 | 600 |
| 17 | 7 | 100 | 14.3 | 35 | 50 | 15 | 30 | 600 |
| 18 | 100 | 100 | 1.0 | 50 | 51 | 1 | 40 | 3100 |
| 19 | — | 100 | — | — | 50 | — | 30 | 600 |
| 20 | 10 | 100 | 10.0 | 45 | 45 | 0 | 30 | 600 |
| 21 | 10 | 100 | 10.0 | 50 | 45 | −5 | 30 | 600 |
| 22 | 250 | 100 | 0.4 | 35 | 50 | 15 | 30 | 600 |
| 23 | 10 | 100 | 10.0 | 35 | 35 | 0 | 30 | 600 |
| 24 | 10 | 100 | 10.0 | 35 | 50 | 15 | 30 | — |
| 25 | 10 | 100 | 10.0 | 45 | 45 | 0 | 30 | — |
| 26 | 10 | 100 | 10.0 | 50 | 45 | −5 | 30 | — |

(Uniformity)

Each of the recorded products recorded under the conditions of Table 3 and Table 4 was left to stand under an environment at a temperature of 23° C. and a relative humidity of 50% for 24 hours. After that, an image of the recorded product was captured under the conditions of a professional mode, a resolution of 300 dpi, and a color of 24 bits with a scanner (product name: “OFFIRIO ES-10000G”, manufactured by Seiko Epson Corp.). In order to evaluate the uniformity of the captured image, a range measuring 150 pixels by 150 pixels was converted to a grayscale image with image and photo editing software (product name: “Adobe Photoshop”, manufactured by Adobe Inc.), and a standard deviation obtained from a histogram was determined. Then, the uniformity of the image was evaluated in accordance with the following evaluation criteria through use of the resultant standard deviation.

AAA: The standard deviation was less than 2.5.

AA: The standard deviation was 2.5 or more to less than 3.0.

A: The standard deviation was 3.0 or more to less than 3.5.

B: The standard deviation was 3.5 or more to less than 4.0.

C: The standard deviation was 4.0 or more.

(Sticky resistance)

The evaluation of sticky resistance of each of the images recorded under the conditions shown in Table 3 and Table 4 was performed under the following conditions. Specifically, the resultant recorded product was left to stand under an environment at a temperature of 30° C. and a relative humidity of 80% for 24 hours. Subsequently, an unrecorded recording medium was caused to overlap the recorded product so as to be brought into contact with a portion of the image of the recorded product. Then, a load of 1,500 kg/m² was applied to the overlapping two recording mediums, and the overlapping two recording mediums were left to stand under the above-mentioned environment for 24 hours. After leaving, the overlapping two recording media and the state of the image were observed, and the sticky resistance of the image was evaluated in accordance with the following evaluation criteria.

AA: The two recording mediums did not adhere to each other.

A: The two recording mediums were separated from each other only by touch.

B: The two recording mediums were not separated from each other even by turning the recording medium upside down, but were easily separated from each other by fixing the unrecorded recording medium and shaking the overlapping two recording mediums.

C: The two recording mediums were not separated from each other even by shaking, but were able to be peeled off.

TABLE 4-1
Evaluation conditions and evaluation results

| | | Evaluation condition | | | | Evaluation result | |
|---|---|---|---|---|---|---|---|
| | | Reaction | | Recording | Recording | | Sticky |
| | | liquid | Ink | condition | Medium | Uniformity | resistance |
| Example | 1 | 1 | 1 | 1 | 1 | AAA | AA |
| | 2 | 1 | 2 | 1 | 1 | AAA | AA |
| | 3 | 1 | 3 | 1 | 1 | AAA | AA |
| | 4 | 1 | 4 | 1 | 1 | AAA | AA |
| | 5 | 1 | 5 | 1 | 1 | AAA | AA |
| | 6 | 2 | 1 | 2 | 1 | A | AA |
| | 7 | 3 | 1 | 1 | 1 | A | AA |
| | 8 | 4 | 1 | 1 | 1 | AA | AA |
| | 9 | 5 | 1 | 1 | 1 | AA | AA |
| | 10 | 6 | 1 | 1 | 1 | AAA | AA |
| | 11 | 7 | 1 | 1 | 1 | AAA | AA |
| | 12 | 1 | 6 | 1 | 1 | AA | AA |
| | 13 | 1 | 7 | 1 | 1 | AAA | AA |
| | 14 | 1 | 8 | 1 | 1 | AAA | AA |
| | 15 | 8 | 1 | 1 | 1 | AA | AA |
| | 16 | 9 | 1 | 1 | 1 | AAA | AA |
| | 17 | 10 | 1 | 1 | 1 | AAA | AA |
| | 18 | 11 | 1 | 1 | 1 | AAA | AA |
| | 19 | 12 | 1 | 1 | 1 | AAA | AA |
| | 20 | 13 | 1 | 1 | 1 | AAA | AA |
| | 21 | 14 | 1 | 1 | 1 | AA | AA |
| | 22 | 15 | 1 | 3 | 1 | AAA | AA |
| | 23 | 16 | 1 | 1 | 1 | A | AA |
| | 24 | 17 | 1 | 1 | 1 | B | AA |
| | 25 | 18 | 1 | 1 | 1 | AAA | AA |
| | 26 | 19 | 1 | 1 | 1 | AAA | AA |
| | 27 | 20 | 1 | 1 | 1 | AA | A |
| | 28 | 21 | 1 | 1 | 1 | AA | A |
| | 29 | 22 | 1 | 1 | 1 | AA | A |
| | 30 | 23 | 1 | 4 | 1 | B | AA |
| | 31 | 24 | 1 | 1 | 1 | AA | AA |
| | 32 | 25 | 1 | 1 | 1 | AA | AA |
| | 33 | 26 | 1 | 1 | 1 | AA | AA |
| | 34 | 27 | 1 | 1 | 1 | AAA | A |
| | 35 | 28 | 1 | 1 | 1 | AAA | A |
| | 36 | 29 | 1 | 1 | 1 | AAA | B |
| | 37 | 30 | 1 | 1 | 1 | AAA | B |

TABLE 4-2
Evaluation conditions and evaluation results

| | | Evaluation condition | | | | Evaluation result | |
|---|---|---|---|---|---|---|---|
| | | Reaction | | Recording | Recording | | Sticky |
| | | liquid | Ink | condition | Medium | Uniformity | resistance |
| Example | 38 | 31 | 1 | 1 | 1 | AAA | B |
| | 39 | 32 | 1 | 1 | 1 | AAA | B |
| | 40 | 1 | 1 | 5 | 1 | AA | AA |
| | 41 | 1 | 1 | 6 | 1 | AAA | AA |
| | 42 | 1 | 1 | 1 | 2 | AAA | AA |
| | 43 | 1 | 1 | 1 | 3 | AA | AA |
| | 44 | 1 | 1 | 7 | 1 | AAA | AA |
| | 45 | 1 | 1 | 8 | 1 | AAA | AA |
| | 46 | 1 | 1 | 9 | 1 | AA | AA |
| | 47 | 1 | 1 | 10 | 1 | AA | AA |
| | 48 | 1 | 1 | 11 | 1 | AAA | AA |
| | 49 | 1 | 1 | 12 | 1 | AAA | AA |
| | 50 | 1 | 1 | 13 | 1 | AAA | AA |
| | 51 | 1 | 1 | 14 | 1 | AAA | AA |
| | 52 | 1 | 1 | 15 | 1 | AA | AA |
| | 53 | 33 | 1 | 16 | 1 | AA | AA |
| | 54 | 34 | 1 | 4 | 1 | AAA | AA |
| | 55 | 34 | 1 | 17 | 1 | AAA | AA |
| | 56 | 35 | 1 | 18 | 3 | B | B |
| Comparative | 1 | None | 1 | 19 | 1 | C | AA |
| Example | 2 | 1 | 1 | 20 | 1 | C | AA |
| | 3 | 1 | 1 | 20 | 2 | C | AA |
| | 4 | 1 | 1 | 21 | 1 | C | AA |
| | 5 | 1 | 1 | 21 | 2 | C | AA |
| | 6 | 36 | 1 | 22 | 1 | C | AA |
| | 7 | 36 | 1 | 22 | 2 | C | AA |
| | 8 | 37 | 1 | 1 | 1 | AA | C |
| | 9 | 37 | 1 | 1 | 2 | AA | C |
| | 10 | 38 | 1 | 1 | 1 | B | C |
| | 11 | 39 | 1 | 23 | 1 | C | AA |
| Reference | 1 | 1 | 1 | 24 | 1 | AAA | AA |
| example | 2 | 1 | 1 | 25 | 1 | AAA | AA |
| | 3 | 1 | 1 | 26 | 1 | AAA | AA |
| | 4 | 1 | 1 | 1 | 4 | A | AA |
| | 5 | 1 | 1 | 20 | 4 | A | AA |
| | 6 | 1 | 1 | 21 | 4 | A | AA |

(Evaluation using Plurality of Inks: Examples 57 and 58)

The same evaluations as those described above were performed as Examples 57 and 58 through use of the reaction liquid and four kinds of inks. The reaction liquid 1 and the inks 1 to 4 were combined to form sets of the inks and the reaction liquids. The reaction liquids and the inks for forming the sets were each filled into the second reaction liquid applying device 1202 and second ink applying device 1203 of the ink jet recording apparatus 100 having a configuration illustrated in FIG. 1. The filling positions of the inks 1 to 4 were assigned to those of the inks in the second ink applying device 1203, respectively, from the upstream side in the conveyance direction of the recording medium. The application amount of each of the inks was set to a duty of 25% to set a total of the application amounts of the inks to a duty of 100%. The time difference between the application of the reaction liquid to the recording medium and the application of each of the inks to the recording medium was set as described below. In Example 57, the time difference between the reaction liquid and the ink 1 was set to 750 msec, the time difference between the reaction liquid and the ink 2 was set to 1,500 msec, the time difference between the reaction liquid and the ink 3 was set to 2,250 msec, and the time difference between the reaction liquid and the ink 4 was set to 3,000 msec. In addition, in Example 58, the time difference between the reaction liquid and the ink 1 was set to 800 msec, the time difference between the reaction liquid and the ink 2 was set to 1,600 msec, the time difference between the reaction liquid and the ink 3 was set to 2,400 msec, and the time difference between the reaction liquid and the ink 4 was set to 3,200 msec. Evaluations were performed in accordance with the same procedure and evaluation criteria as those in Example 1 except for the foregoing. In Example 57, the uniformity was evaluated to be AAA, and the sticky resistance was evaluated to be AA. In Example 58, the uniformity was evaluated to be AA, and the sticky resistance was evaluated to be AA.

According to the present invention, there can be provided the ink jet recording method capable of recording an image having satisfactory uniformity and suppressed stickiness on a low-absorbent recording medium or a non-absorbent recording medium. In addition, according to the present invention, the ink jet recording apparatus to be used in the ink jet recording method can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-188253, filed Nov. 25, 2022, and Japanese Patent Application No. 2023-194800, filed Nov. 16, 2023, which are hereby incorporated by reference herein in their entirety.

What is claimed is:

1. An ink jet recording method comprising recording an image on a recording medium comprising a water absorption amount from contact start to 30 msec^{1/2} in a Bristow method of 10 mL/m² or less with an aqueous ink and an aqueous reaction liquid comprising a reactant that reacts with the aqueous ink by applying the aqueous ink and the reaction liquid to a unit region with one relative scanning between a recording head and the recording medium, the ink jet recording method comprising:
a reaction liquid applying step of applying the reaction liquid to the recording medium by ejecting the reaction liquid from a first ejection head of an ink jet system; and
an ink applying step of applying the aqueous ink to the recording medium by ejecting the aqueous ink from a second ejection head of an ink jet system so that a region to which the aqueous ink is applied and a region to which the reaction liquid is applied are at least partially overlap on the recording medium,
wherein a temperature of the reaction liquid at a time of being ejected from the first ejection head is lower than a temperature of the aqueous ink at a time of being ejected from the second ejection head, and
wherein the reactant comprises a polyvalent metal salt, and the polyvalent metal salt comprises a water solubility at 20° C. of 1% by mass or more to 50% by mass or less.

2. The ink jet recording method according to claim 1, wherein an application amount of the aqueous ink to the unit region of the recording medium is larger than an application amount of the reaction liquid to the unit region of the recording medium.

3. The ink jet recording method according to claim 1, wherein a content (% by mass) of water in the reaction liquid is 75.0% by mass or more with respect to a total mass of the reaction liquid.

4. The ink jet recording method according to claim 1, wherein a content (% by mass) of water in the reaction liquid is 85.0% by mass or more with respect to a total mass of the reaction liquid.

5. The ink jet recording method according to claim 1, wherein a content (% by mass) of water in the aqueous ink is 60.0% by mass or more with respect to a total mass of the aqueous ink.

6. The ink jet recording method according to claim 1, wherein the reaction liquid comprises a surface tension at 25° C. of 27 mN/m or more.

7. The ink jet recording method according to claim 1, wherein the reaction liquid contains a hydrocarbon-based surfactant.

8. The ink jet recording method according to claim 1, wherein the reaction liquid comprises a viscosity at 25° C. of 3.0 mPa·s or less.

9. The ink jet recording method according to claim 1, wherein the reaction liquid comprises at least one kind of water-soluble organic solvent selected from the group consisting of: 1,2-propanediol; 1,2-butanediol; 1,2-hexanediol; 1,3-butanediol; 1,4-butanediol; and 2,3-butanediol.

10. The ink jet recording method according to claim 1, wherein the polyvalent metal salt is at least one kind selected from the group consisting of: an inorganic polyvalent metal salt; and a polyvalent metal salt of a monovalent organic acid.

11. The ink jet recording method according to claim 1, wherein the polyvalent metal salt comprises a water solubility at 20° C. of 8% by mass or more to 30% by mass or less.

12. The ink jet recording method according to claim 1, wherein the polyvalent metal salt is magnesium sulfate.

13. The ink jet recording method according to claim 1, wherein a temperature of the recording medium at a time of application of the reaction liquid thereto is equal to or less than the temperature of the reaction liquid at the time of being ejected from the first ejection head.

14. The ink jet recording method according to claim 1, wherein the water absorption amount of the recording medium from contact start to 30 msec^{1/2} in the Bristow method is less than 5 mL/m².

15. An ink jet recording apparatus for use in an ink jet recording method comprising recording an image on a recording medium comprising a water absorption amount from contact start to 30 msec^{1/2} in a Bristow method of 10 mL/m² or less with an aqueous ink and an aqueous reaction liquid comprising a reactant that reacts with the aqueous ink by applying the aqueous ink and the reaction liquid to a unit region with one relative scanning between a recording head and the recording medium, the ink jet recording method comprising:
a reaction liquid applying step of applying the reaction liquid to the recording medium by ejecting the reaction liquid from a first ejection head of an ink jet system; and
an ink applying step of applying the aqueous ink to the recording medium by ejecting the aqueous ink from a second ejection head of an ink jet system so that a region to which the aqueous ink is applied and a region to which the reaction liquid is applied are at least partially overlap on the recording medium,
wherein a temperature of the reaction liquid at a time of being ejected from the first ejection head is lower than a temperature of the aqueous ink at a time of being ejected from the second ejection head, and
wherein the reactant contains a polyvalent metal salt, and the polyvalent metal salt has a water solubility at 20° C. of 1% by mass or more to 50% by mass or less.
